(19) United States
(12) Patent Application Publication
(10) Pub. No.: US 2023/0330873 A1
(43) Pub. Date: Oct. 19, 2023

(54) METHOD AND APPARATUS FOR PROXIMITY DETECTION AND PROXIMITY DIRECTION ESTIMATION

(71) Applicant: SAMSUNG ELECTRONICS CO, Ltd., Suwon-si (KR)

(72) Inventors: Siddharth RUPAVATHARAM, Piscataway, NJ (US); Xiaoran FAN, Irvine, CA (US); Daewon LEE, Princeton, NJ (US); Richard HOWARD, Highland Park, NJ (US); Lawrence JACKEL, Holmdel, NJ (US); Ibrahim Volkan ISLER, Saint Paul, MN (US); Daniel LEE, Tenafly, NJ (US)

(73) Assignee: SAMSUNG ELECTRONICS CO, Ltd., Suwon-si (KR)

(21) Appl. No.: 18/132,791

(22) Filed: Apr. 10, 2023

Related U.S. Application Data
(60) Provisional application No. 63/330,989, filed on Apr. 14, 2022.

(51) Int. Cl. B25J 19/02; B25J 9/16

(52) U.S. Cl. CPC B25J 19/026; B25J 9/161; B25J 9/1656; B25J 9/1676; B25J 19/028

(57) ABSTRACT

An apparatus for estimating a proximity direction of an obstacle includes an acoustic transmitter attached to a surface of the apparatus; a first acoustic receiver spaced apart from the surface of the apparatus; a second acoustic receiver spaced apart from the surface of the apparatus; and at least one processor configured to: control the acoustic transmitter to generate an acoustic wave along the surface; obtain first and second proximity direction signals based on first and second acoustic wave signals corresponding to the generated acoustic wave; and estimate a proximity direction of the obstacle with respect to the apparatus based on the first and second proximity direction signals.

### CROSS-REFERENCE TO RELATED APPLICATION

This application is based on and claims priority under 35 U.S.C. § 119 from U.S. Provisional Application No. 63/330,989 filed on Apr. 14, 2022, in the U.S. Patent & Trademark Office, the disclosure of which is incorporated by reference herein in its entirety.

### BACKGROUND

### 1. Field

The disclosure relates to a method and an apparatus for proximity direction estimation for robot collision avoidance.

### 2. Description of Related Art

As robots work in dynamic environments, unexpected collisions with people, objects, and obstacles must be avoided. A robot colliding with the environment can damage itself or its surroundings, and can harm humans in the workspace. Collision avoidance systems enable the robot to detect approaching obstacles before collision, and take measures to avoid or mitigate impact. Such systems may be particularly necessary for robotic manipulators such as robot arms to safely operate in uncertain and dynamic environments. As such, there has been extensive research on collision avoidance systems for robotic manipulators. Avoiding collisions is also important for mobile robots. Examples include robot vacuum cleaners, robot floor cleaners, and outdoor self-navigating robots such as lawn mowers and trash collectors.

There are many scenarios in which collision avoidance depends on accurate short-range sensing. Many existing collision avoidance methods use cameras and computer vision-based object recognition or three-dimensional (3D) shape reconstruction to detect and react to obstacles. However, these approaches have several limitations. Their performance suffers when faced with visual occlusions, poor light conditions, and transparent or mirrored objects that are difficult to detect visually. Further, camera-based approaches are typically not accurate over very short ranges (less than 10 cm) depending on camera focal length, and any single camera has a limited field of view.

To address this need for short-range detection, proximity sensors such as ultrasonic proximity sensors, millimeter wave radar, infrared proximity sensors, and short-range light detecting and ranging (LiDAR) have been proposed for robot collision avoidance. These methods also have limitations. For example, LiDAR and millimeter wave radar are expensive, and also emanate from a point source and thus have blind spots. Effective coverage may require a large number of sensors distributed throughout the robot, and blind spots can be difficult to eliminate entirely. This complicates robotic system design and adds a significant amount of extra cost and sensor management overhead.

### SUMMARY

In accordance with an aspect of the disclosure, there is provided an apparatus for estimating a proximity direction of an obstacle, including an acoustic transmitter attached to a surface of the apparatus; a first acoustic receiver spaced apart from the surface; a second acoustic receiver be spaced apart from the surface, wherein a position of the second acoustic receiver is different from a position of the first acoustic receiver with respect to the apparatus; a memory configured to store instructions; and at least one processor configured to execute the instructions to: control the acoustic transmitter to generate an acoustic surface wave along the surface; obtain a first proximity direction signal based on the first acoustic wave signal; obtain a second proximity direction signal based on the second acoustic wave signal; and estimate a proximity direction of an obstacle with respect to the apparatus based on the first proximity direction signal and the second proximity direction signal.

In accordance with an aspect of the disclosure, there is provided a method for estimating a proximity direction of an obstacle, the method being executed by at least one processor and including controlling an acoustic transmitter attached to a surface of an electronic device to generate an acoustic wave along the surface; obtaining a first proximity direction signal based on a first acoustic wave signal received via a first acoustic receiver spaced apart from the surface of the electronic device, wherein the first acoustic wave signal corresponds to the generated acoustic wave; obtaining a second collision direction signal based on a second acoustic wave signal received via a second acoustic receiver spaced apart from the surface of the electronic device, wherein a position of the second acoustic receiver is different from a position of the first acoustic receiver with respect to the electronic device, and wherein the second acoustic wave signal corresponds to the generated acoustic wave; and estimating the proximity direction of the obstacle with respect to the electronic device based on the first proximity direction signal and the second proximity direction signal.

In accordance with an aspect of the disclosure, there is provided a non-transitory computer-readable storage medium storing instructions that, when executed by at least one processor of an electronic device for estimating a proximity direction of an obstacle, cause the at least one processor to: control an acoustic transmitter attached to a surface of the electronic device to generate an acoustic wave along the surface; obtain a first proximity direction signal based on a first acoustic wave signal received via a first acoustic receiver spaced apart from the surface of the electronic device, wherein the first acoustic wave signal corresponds to the generated acoustic wave; obtain a second collision direction signal based on a second acoustic wave signal received via a second acoustic receiver spaced apart from the surface of the electronic device, wherein a position of the second acoustic receiver is different from a position of the first acoustic receiver with respect to the electronic device, and wherein the second acoustic wave signal corresponds to the generated acoustic wave; and estimate the proximity direction of the obstacle with respect to the electronic device based on the first proximity direction signal and the second proximity direction signal.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1A is a diagram illustrating an apparatus for proximity detection and proximity direction estimation, according to embodiments;

FIG. 1B is a block diagram illustrating an example processing flow corresponding to the apparatus of FIG. 1A, according to embodiments;

FIGS. 2A-2D are diagrams illustrating examples of proximity direction detection for obstacles at various positions, according to embodiments;

FIG. 3 is a diagram illustrating an acoustic wave emanating from an object, according to embodiments;

FIG. 4 shows a graph illustrating a signal received at a surface of the apparatus of FIG. 1A, ;

FIGS. 5A-5B are diagrams illustrating a process of generating and receiving a signal with and without an obstacle approaching the apparatus of FIG. 1A, according to embodiments, and FIG. 5C shows a graph illustrating a signal received above a surface of the apparatus of FIG. 1A, according to embodiments;

FIGS. 6, 7A-7B, 8A-8B, 9, and 10A-10B are a diagrams illustrating examples of acoustic receivers, according to embodiments;

FIG. 11 is a block diagram illustrating an example of a signal processing flow performed by the apparatus of FIG. 1A, according to embodiments;

FIG. 12 shows a graph illustrating a received signal due to an obstacle approaching, touching and retreating from the apparatus of FIG. 1A;

FIG. 13 is a flowchart illustrating an example process for detecting a proximity event corresponding to an obstacle, according to embodiments;

FIG. 14 illustrates an example proximity detection algorithm, according to embodiments;

FIG. 15 is a scalogram corresponding to a received signal due to an obstacle approaching, touching and retreating from the apparatus of FIG. 1A, according to embodiments;

FIG. 16 illustrates an example threshold value calculation algorithm, according to embodiments;

FIGS. 17A-17B illustrate example outputs of a proximity detection algorithm, according to embodiments;

FIG. 18 is a diagram illustrating an example process for estimating a relative proximity direction between an obstacle and the apparatus of FIG. 1A, according to embodiments;

FIG. 19 illustrates an example proximity direction estimation algorithm, according to embodiments;

FIGS. 20A-20F are diagrams illustrating obstacles at various positions with respect to the apparatus of FIG. 1A, according to embodiments;

FIGS. 21A-21F show graphs illustrating received signals due to obstacle located at various positions with respect to the apparatus of FIG. 1A;

FIGS. 22A-22B illustrate example results of proximity detection and proximity direction estimation corresponding to the apparatus of FIG. 1A;

FIG. 23A is a block diagram of an example robot control system, according to embodiments;

FIG. 23B is a block diagram of an example robot control system which incorporates the apparatus of FIG. 1A, according to embodiments;

FIG. 23C is a block diagram of an example robot control system which incorporates the apparatus of FIG. 1A, according to embodiments;

FIGS. 24A-24B are flowcharts of methods of for proximity detection and proximity direction estimation for robot collision avoidance, according to embodiments; and

FIG. 25 is a block diagram of an electronic device in which the apparatus of FIG. 1A is implemented, according to embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

Embodiments described herein relate to a sensing modality which may enable short-range proximity detection for objects such as robot arms. A proximity detection and proximity direction estimation system using this principle may be lightweight and inexpensive, and may be attached to an off-the-shelf robotic manipulator with minimal modifications, and provide proximity detection of all objects with sufficient cross-sectional area across an entire surface of a robot. In embodiments, the system can perform full surface and omnidirectional proximity detection and proximity direction estimation using, for example, only a single acoustic transmitter and one or more acoustic receivers, for example a pair of acoustic receivers.

In embodiments, a proximity detection and proximity direction estimation system may use an acoustic transmitter and a pair of acoustic receivers attached to a robot arm. In embodiments, the acoustic transmitter may be, for example, a piezoelectric transmitter or transducer, and the acoustic receivers may be, for example, piezoelectric receivers or transducers. In embodiments, the acoustic transmitter may transmit excitation signals through the robot arm to the one or more acoustic receivers. This acoustic energy may transfer through a whole surface of the robot arm, which may in turn couple with surrounding air and emanate an acoustic signal. This emanated signal may decay in the air, forming an “aura” surrounding the robot surface.

An approaching obstacle that enters this aura will establish a standing wave pattern between the obstacle and the robot surface, changing an acoustic impedance of a system. In embodiments, the term “obstacle” may refer to an object which may present a potential collision which is to be avoided, however embodiments are not limited thereto. For example, in embodiments the term “obstacle” may refer to an object which is a target of investigation, or a target of a potential interaction, for example an object which is to moved, touched, pressed, grasped, etc. This change can be measured by the pair of acoustic receivers attached to the arm at a point far from the obstacle, allowing the system to perform proximity detection. In embodiments, the term “attached” may mean directly attached, however embodiments are not limited thereto. For example, in embodiments the term “attached” may mean indirectly attached, and the acoustic receivers may be for example attached to one or more intervening elements which may be directly attached to the arm. In embodiments, the term “attached” may also mean, for example, directly or indirectly disposed, fastened, affixed, coupled, connected, secured, linked, joined, etc. The proximity detection and proximity direction estimation system according to one or more embodiments may be implemented using other sound producers, such as speakers and microphones, without using piezoelectric elements.

A major component of a signal is received from a surface of a robot rather than an over-the-air signal. However, only the over-the-air signal may contain information useful for proximity detection. Further, a robot arm itself introduces both mechanical and electrical noise that can be received by an attached acoustic receiver.

Therefore, according to embodiments, the acoustic receivers may be mechanically decoupled from the surface, for example by suspending the acoustic receivers in the air just above the surface, in order to minimize the component of the signal received from the surface of the robot. In addition, according to embodiments, the pair of acoustic receivers may be located at two different locations, and differences between the signals received at the two different locations may be used to provide proximity direction estimation corresponding to the approaching obstacle based on the received signals. In embodiments, the proximity direction estimation may be performed by or include comparing the received signals to one or more threshold values, or for example one or more reference signals, in order to estimate a relative direction of the approaching obstacle with respect to the robot arm. However, embodiments are not limited thereto, and the proximity direction estimation may be performed by comparing the received signals with each other, for example by comparing at least one of the received signals with at least another of the received signal.

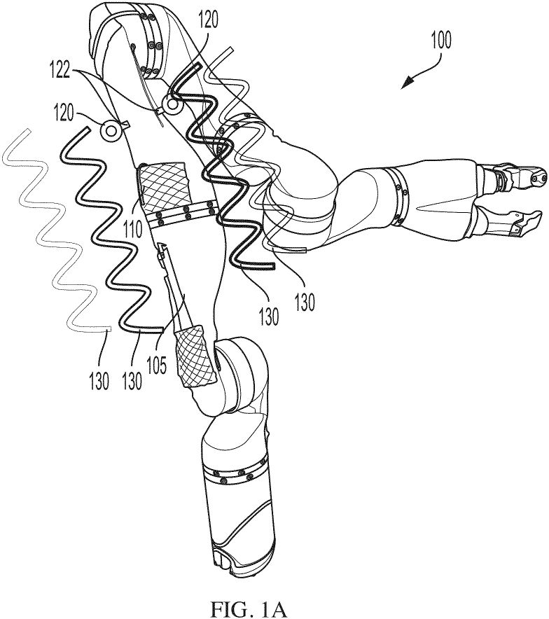

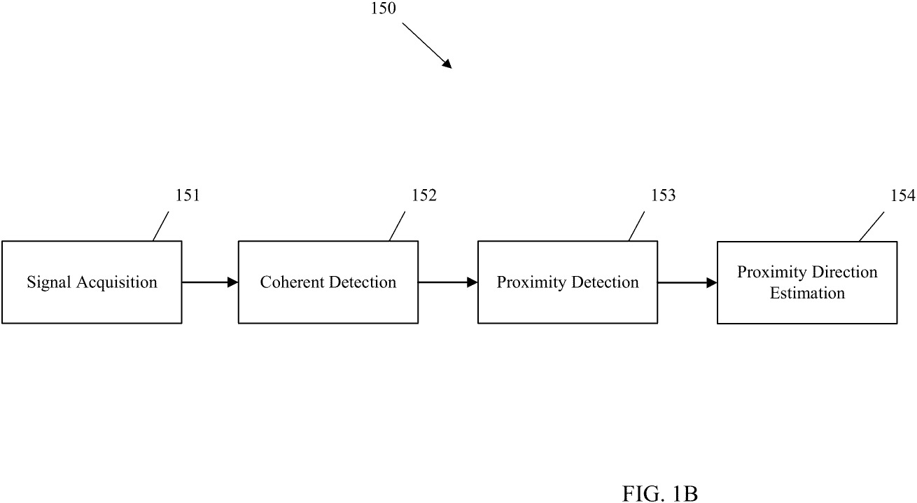

FIG. 1A is a diagram illustrating an apparatus 100 for proximity detection and proximity direction estimation, according to embodiments. FIG. 1B is a block diagram illustrating an example of a process 150 for proximity detection and proximity direction estimation which may be performed using the apparatus 100, according to embodiments.

The apparatus 100 and any portion of the apparatus 100 may be included or implemented in a robot and/or an electronic device. Although apparatus 100 is illustrated as a robotic arm in FIG. 1A, embodiments are not limited thereto, and apparatus 100 may include any type of robot and/or electronic device. The electronic device may include any type of electronic device, for example, a smartphone, a laptop computer, a personal computer (PC), a smart television and the like.

As shown in FIG. 1A, the apparatus 100 includes an acoustic transmitter 110 and a plurality of acoustic receivers 120, for example a first acoustic receiver 120a and a second acoustic receiver 120b. The acoustic transmitter 110 and the acoustic receivers 120 may be, for example, piezoelectric elements such as piezoelectric transmitters, receivers, or transducers, but embodiments are not limited thereto. In embodiments, the piezoelectric transmitters, receivers, or transducers may have a resonant frequency in an ultrasonic frequency range, for example around 7 kHz or around 19 kHz, however embodiments are not limited thereto.

The acoustic transmitter 110 and the acoustic receivers 120 are disposed adjacent to a surface 105 of an the apparatus 100, which may be for example a robot and/or an electronic device. For example, the acoustic transmitter 110 may be coupled to, disposed on, or embedded within the surface 105 of a robot arm, and the acoustic receivers 120 may be suspended above the surface 105 of the robot arm. In embodiments, the acoustic receivers 120 may be suspended by corresponding connection structures 122. For example, first acoustic receiver 120a may be coupled to first connection structure 122a, which may be coupled to, disposed on, or embedded within the surface 105, and which may suspend the first acoustic receiver 120a at a certain height about the surface 105. Similarly, second acoustic receiver 120b may be coupled to second connection structure 122b, which may be coupled to, disposed on, or embedded within the surface 105, and which may suspend the second acoustic receiver 120b at a certain height about the surface 105. In embodiments, the first acoustic receiver 120a and the second acoustic receiver 120b may be suspended at the same height above the surface 105, however embodiments are not limited thereto, and the first acoustic receiver 120a and the second acoustic receiver 120b may be suspended at different heights above the surface 105.

As shown in FIG. 1B, at operation 151, the process 150 includes generating and acquiring a signal. For example, at least one processor of the apparatus 100 may control the acoustic transmitter to generate an acoustic wave 130 within and along the surface 105 of the apparatus 100. The portion of the acoustic wave 130 which is transmitted into the air around the surface 105 may be referred to as an emanated acoustic wave, as it may emanate from or surround the surface 105 of the object. For example, at least one processor may apply an excitation signal to a piezoelectric element included in the acoustic transmitter 110 to control the piezoelectric element to generate the acoustic wave 130.

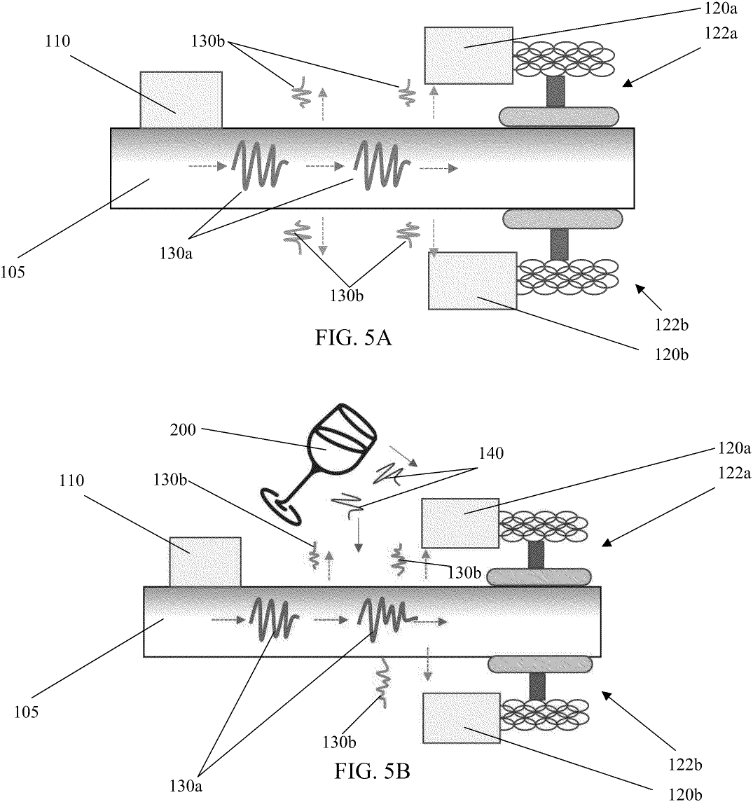

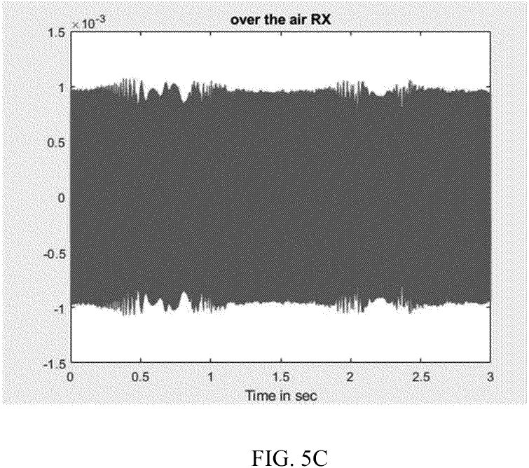

If the apparatus 100 is made out of elastic materials, such as plastic or metal, the surface 105 of the apparatus 100will vibrate and couple with the air, and the entire surface 105 of the apparatus 100 functions as an acoustic transducer, however embodiments are not limited thereto, and in embodiments only a portion of the surface 105 of the apparatus 100 may vibrate. In embodiments, the acoustic transmitter 110 couples with the surface 105 instead of air, and could even be embedded within the apparatus 100. Then, the at least one processor receives, via the acoustic receivers 120, a plurality of acoustic wave signals corresponding to the generated acoustic wave 130. Based on an obstacle being nearby the apparatus 100, the generated acoustic wave 130 becomes a deformed acoustic wave 140 (as shown for example in FIG. 5B) within and along the surface 105 of the apparatus 100. The at least one processor may receive, via the acoustic receivers 120, one or more deformed acoustic wave signals corresponding to the deformed acoustic wave 140.

As further shown in FIG. 1B, at operation 152, the process 150 includes coherent detection corresponding to the received acoustic wave signals. For example, the at least one processor of the apparatus 100 may collect data from the acoustic wave signals for a set amount of time before it is processed. The number of data samples collected may correspond to the length of time for which the data is collected. This length of time may be referred to as a signal window, and may be, for example, 100 ms, 250 ms, etc., however embodiments are not limited thereto.

In embodiments, signal processing may be performed on the data collected in this signal window. For example, the at least one processor may filter the received acoustic wave signals or the received deformed acoustic wave signals, using a low-pass filter for reducing noise of the received acoustic wave signals or the received deformed acoustic wave signals. As another example, the at least one processor may apply a fast Fourier transform (FFT) to the received acoustic wave signals or the received deformed acoustic wave signals, in order to determine signal powers of the received acoustic wave signals or the received deformed acoustic wave signals.

As further shown in FIG. 1B, at operation 153, the process 150 includes proximity detection. For example, based on a comparison between a threshold value and the processed data, a proximity determination may be made. In embodiments, based on the proximity determination indicating that a proximity event has occurred, the at least one processor may determine that an obstacle is proximate to, or within a certain distance of, the apparatus 100.

As further shown in FIG. 1B, at operation 154, the process 150 includes proximity direction estimation. For example, based on a comparison between one or more threshold values and the processed data, a proximity direction determination may be made. In embodiments, based on determining that the obstacle is proximate to the apparatus 100, the at least one processor may then estimate a proximity direction of the obstacle relative to the apparatus 100.

Although FIG. 1B illustrates the proximity direction estimation of operation 154 as occurring after the proximity detection of operation 153, embodiments are not limited thereto. For example, the process 150 may include only the proximity detection of operation 153 without including the proximity direction estimation of operation 154, or may include only the proximity direction estimation of operation 154 without a separate proximity detection being performed in operation 153.

Based on the apparatus 100being the robot, and based on the obstacle being determined to be proximate to the surface 105 of the apparatus 100, the at least one processor may control the apparatus 100 to avoid collision with the obstacle. In embodiments, the at least one processor may use the estimated proximity direction in order to avoid the collision.

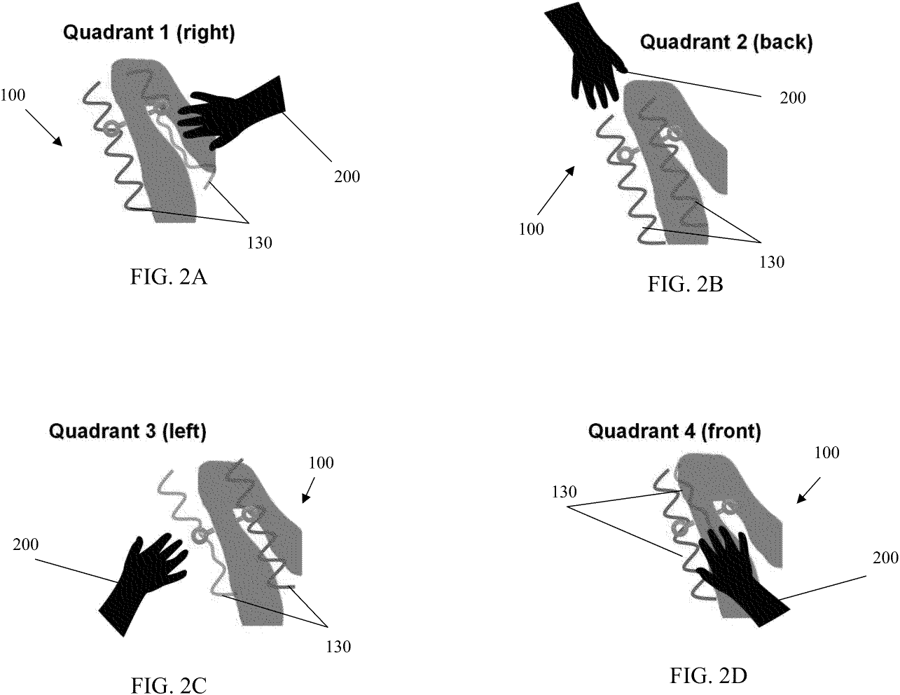

FIGS. 2A-2D are diagrams illustrating examples of proximity detection and proximity direction estimation for obstacles at various positions, according to embodiments. In embodiments, the relative proximity direction may be expressed in terms of quadrants with respect to the apparatus 100. For example, FIG. 2A shows an obstacle 200 approaching the object from a first quadrant, quadrant 1, which may be to a right of the object. FIG. 2B shows the obstacle 200 approaching the object from a second quadrant, quadrant 2, which may be behind or toward a back of the object. FIG. 2C shows the obstacle 200 approaching the object from a third quadrant, quadrant 3, which may be to a left of the object. FIG. 2D shows the obstacle 200 approaching the object from a fourth quadrant, quadrant 4, which may be toward a front of the object.

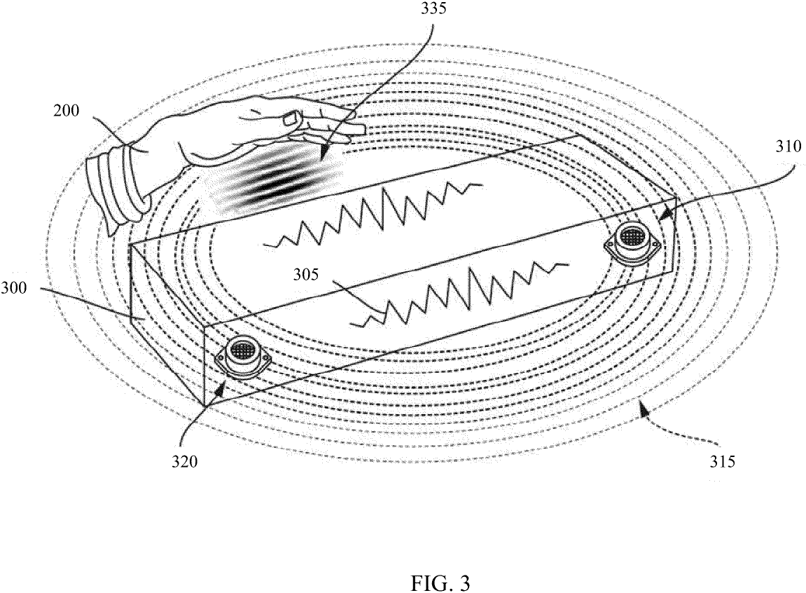

FIG. 3 is a diagram illustrating an acoustic wave emanating from an object, according to embodiments. A schematic illustrating how the acoustic wave can be distorted is shown in FIG. 3. While most of an acoustic wave 305 generated by a piezoelectric transmitter 310 stays on a surface of an object 300, a small amount is emanated into air as an emanated acoustic wave 315. This emanated acoustic wave315 decays exponentially in the air, resulting in an acoustic “aura” around the surface of the object 300. This “aura” is an acoustic pressure field surrounding the object 300.

An obstacle 200 close to the surface of the object 300 will establish a standing wave pattern 335 or interference pattern between the obstacle 200 and the object surface, which perturbs the acoustic pressure field and results in an acoustic impedance change across the entire surface. These changes can be detected by a piezoelectric receiver 320, which may be located on the surface of the object 300. As the acoustic wave 305 propagates through the object 300, obstacles close to any point on the object surface will cause distortions that can be measured at other points on or within the object 300, allowing for a single transmitter/receiver pair of piezoelectric elements to detect the obstacles close to any part of the coupled object 300.

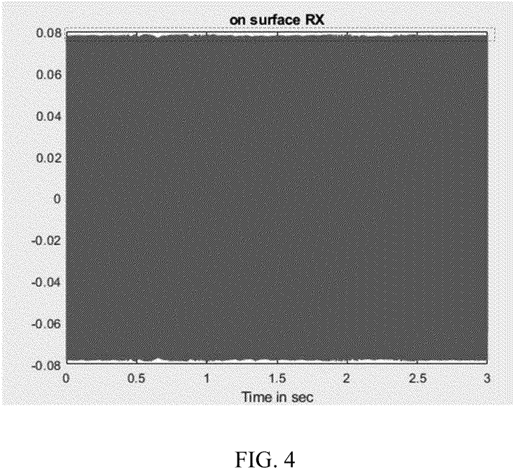

FIG. 4 shows a graph illustrating a signal received at a surface of the apparatus of FIG. 3, according to embodiments. As discussed above, most of the acoustic wave 305 generated by the piezoelectric transmitter 310 stays on a surface of the object 300, and only a small amount forms the emanated acoustic wave315. Therefore, the acoustic wave signal received at the piezoelectric receiver 320, which is located directly on the surface, includes a relatively large component that is received through the surface, and a relatively small component that is received through the air above the surface. However, information regarding a proximity of the obstacle 200 is generated based on distortions in the emanated acoustic wave315, and is therefore mostly contained in small changes in the signal, for example the changes shown in the portion of the signal included within the dotted lines shown in FIG. 4. As a result, when the piezoelectric receiver 320 is directly coupled to the surface of the object 300, small changes in the signal corresponding to an approaching obstacle can be difficult to detect.

Therefore, embodiments provide an apparatus 100 in which the acoustic receivers 120 are suspended in the air just above the surface, in order to allow the acoustic receivers 120 to directly sense the component of the acoustic wave signal which corresponds to the emanated acoustic wave315, while sensing relatively less of the component of the acoustic wave signal that is transmitted mechanically through the surface.

FIGS. 5A-5B are diagrams illustrating a process of generating and receiving a signal with and without an obstacle approaching the apparatus 100, and FIG. 5C shows a graph illustrating a signal received above a surface of the apparatus 100, according to embodiments.

As shown in FIG. 5A, the apparatus 100 uses the acoustic transmitter 110 to generate the acoustic wave 130. As discussed above, a first portion 130a of the acoustic wave 130 travels along the surface 105, and a second portion 130b of the acoustic wave 130 is emanated into the air above the surface 105. In embodiments, the second portion 130b of the acoustic wave 130 may correspond to the emanated acoustic wave discussed above.

The first and second acoustic receivers 120a and 120b may receive acoustic wave signals corresponding to the acoustic wave 130. Because the first and second acoustic receivers 120a and 120b are suspended above the surface 105 by the first and second connection structures 122a and 122b, respectively, the received acoustic wave signals may be influenced relatively more by the second portion 130b of the acoustic wave 130, and may be influenced relatively less by the first portion 130a of the acoustic wave 130. Therefore, when an obstacle 200 approaches the apparatus 100and changes some or all of the second portion 130b of the acoustic wave 130 into a deformed acoustic wave 140, as shown in FIG. 5B, the changes to the acoustic wave signals may be more easily detected.

An example of an acoustic wave signal which may be generated by one of the first and second acoustic receivers 120a and 120b is shown in FIG. 5C. As can be seen in FIG. 5C, because the influence of the first portion 130a of the acoustic wave is reduced in comparison with the signal shown in FIG. 4, the changes in the acoustic wave signal can be more easily observed. For example, the changes in the signal shown in FIG. 4 may be on the order of 1-2 parts per million, while the changes in the signal shown in FIG. 5C may be on the order of 1/10000.

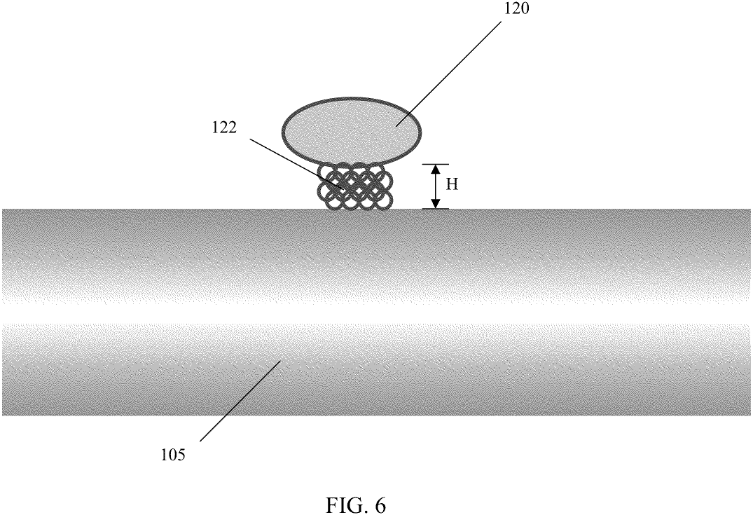

FIGS. 6, 7A-7B, 8A-8B, 9, and 10A-10B are diagrams illustrating examples of the acoustic receiver 120, according to embodiments. In embodiments, the acoustic receiver 120 illustrated in FIGS. 6, 7A-7B, 8A-8B, 9, and 10A-10B may correspond to one or more of the first acoustic receiver 120a and the second acoustic receiver 120b discussed above, and the connection structure 122 illustrated in FIGS. 6, 7A-7B, 8A-8B, 9, and 10A-10B may correspond to one or more of the first connection structure 122a and the second connection structure 122b discussed above.

As shown in FIG. 6, the acoustic receiver 120 is suspended above the surface 105 by a connection structure 122. In embodiments, a first end of the connection structure 122 may be connected to the acoustic receiver 120, and a second end of the connection structure 122 may be connected to the surface, such that the acoustic receiver is spaced apart from the surface by a distance H.

In embodiments, if the connection structure 122 is too tall, then it may be more prone to swaying and hitting obstacles, which may be undesirable. Further, if the connection structure 122 is too rigid then it may conduct mechanical vibrations well, and this may also be undesirable. Accordingly, in embodiments, the connection structure 122 may be a relatively thin, light weight structure that is sufficiently close to the surface.

In embodiments, the connection structure 122 may be constructed such that vibrations of the surface 105 which travel up the connection structure 122 and are transmitted to the acoustic receiver 120, such as the first portion 130a of the acoustic wave 130, may be reduced. In embodiments, the connection structure 122 may include one or more of plastic, foam, wood, or any other material that may reduce vibrations. For example, in embodiments, the connection structure may include a cylinder which is coupled to the surface 105. In embodiments, the cylinder may be hollow in order to reduce a weight of the cylinder. In addition, connection structure 122 may include sound absorbing material such as soundproofing or sound absorbing foam, which may be used to separate the cylinder from the acoustic receiver 120, in order to absorb at least some of the vibrations.

If the acoustic receiver 120 is mounted directly on the surface 105, then a maximum amount of noisy vibrations from the surface 105 is received by the acoustic receiver 120, which is undesirable. If the acoustic receiver 120 is lifted, it can detect changes in the emanated acoustic wave and may be decoupled from the noisy surface vibrations. The distance H may be selected to be sufficiently close to the surface that the acoustic receiver 120 is able to detect the interference pattern setup by the apparatus 100as an obstacle approaches the surface 105. However, the distance H can be selected to be as far away from the surface 105 as desired, as long as the acoustic receiver 120 is still able to detect the emanated acoustic wave . A value for the distance H may be selected based on design and deployment requirements. In embodiments, the distance H may be for example in the range from, for example, 5 millimeters to several centimeters, however embodiments are not limited thereto.

Table 1 below shows signal-to-noise ratios (SNRs) provided by example connection structures 122. In particular, Table 1 shows SNRs corresponding to connection structures 122 constructed of wood and polylactic acid (PLA) which place the acoustic receivers 120 including a piezoelectric receiver at heights of 10 mm and 15 mm above the surface 500.

TABLE 1

| | | |
|---|---|---|
| | Wood | PLA |
| 10 mm | 13.5 dB | 22.1 dB |
| 15 mm | 6.2 dB | 20.7 dB |

In embodiments, the aura provided by the emanated acoustic wave may extend only a short distance from the surface 105, for example, within 3-7 wavelengths depending on the amplitude of the input signal. In embodiments, if the acoustic wave signal transmitted by the acoustic transmitter 110 has a frequency of about 19 kHz, the aura provided by the emanated acoustic wave may extend in the range of about 5.5 cm to about 14 cm above the surface 105. In embodiments, the distance H may be selected to be within about 1 wavelength from the surface 105 in order to ensure that the emanated acoustic wave can be properly detected. In embodiments, a node or peak may be present about a half wavelength above the surface 105, so the distance H may be selected to be within about a half wavelength from the surface 105 in order to maximize the signal provided by the emanated acoustic wave. In addition, in embodiments the size of the acoustic receiver 120 may be selected to be about 1 wavelength in diameter. In embodiments, this may mean that the acoustic receiver may be about 20 mm in diameter, and the distance H may be about 10 mm-20 mm, however embodiments are not limited thereto.

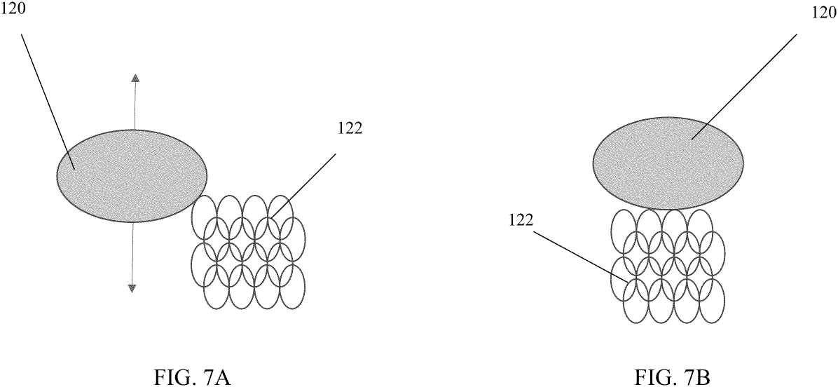

According to embodiments, the acoustic receivers 120 may be lifted from the surface in a variety of different ways. For example, as shown in FIG. 7A, the connection structure 122 may be attached or coupled to an edge of the acoustic receiver 120, which may provide greater sensitivity and may reduce vibration transfer. As another example, as shown in FIG. 7B, the connection structure 122 may be attached or coupled to a center of the acoustic receiver 120, which may reduce sensitivity and increase vibration transfer, but may be more sturdy and may reduce the likelihood of damage to the acoustic receiver 120,

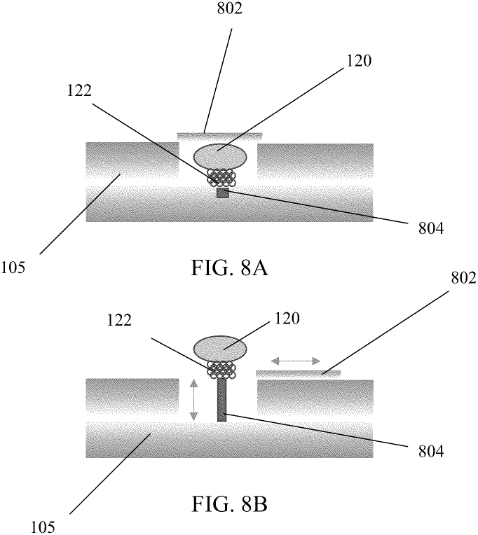

As another example, as shown in FIG. 8A, the connection structure 122 may include an extendable portion 804 which may retract such that the acoustic receiver 120 may be withdrawn below the surface 105 and concealed by a cover 802 when not in use. Then, as shown in FIG. 8B, when the acoustic receiver 120 is to be used, for example when one or more of the proximity detection and proximity direction estimation are to be performed, the cover 802 may slide to expose the acoustic receiver 120, and the extendable portion 804 may extend in order to suspend the acoustic receiver at the distance H above the surface 105.

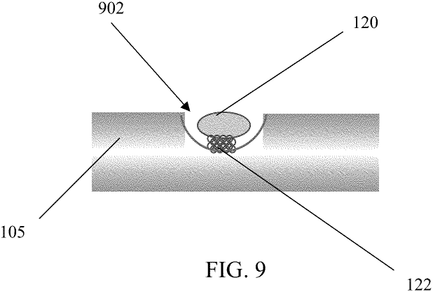

As another example, as shown in FIG. 9, the acoustic receiver 120 and the connection structure 122 may be positioned in a recession 902 in the surface 105, which may reduce the likelihood of damage to the acoustic receiver 120.

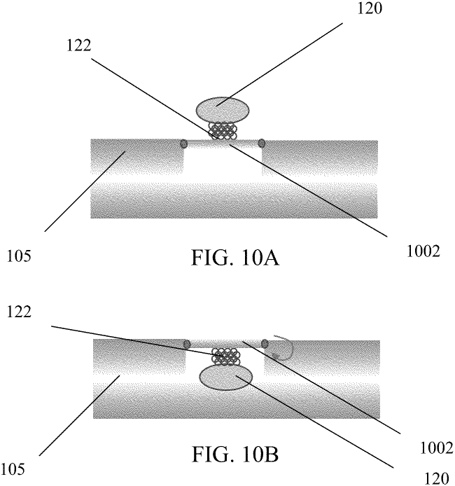

As yet another example, as shown in FIG. 10A, the connection structure 122 may include a rotatable portion 1002 which may rotate such that the acoustic receiver 120 may be withdrawn below the surface 105 when not in use. Then, as shown in FIG. 10B, when the acoustic receiver 120 is to be used, for example when one or more of the proximity detection and proximity direction estimation are to be performed, the rotatable portion 1002 may rotate to expose the acoustic receiver 120 such that the acoustic receiver is suspended at the distance H above the surface 105.

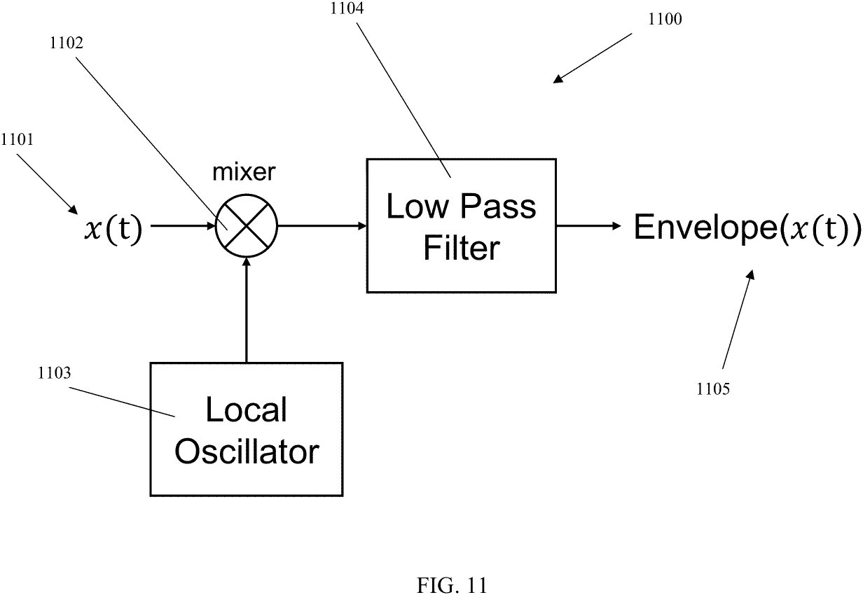

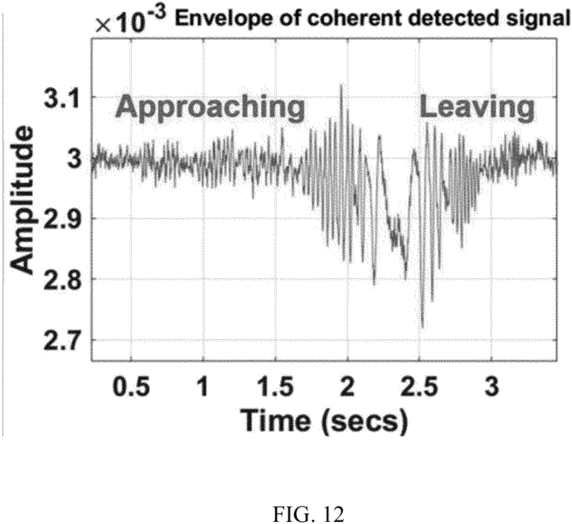

FIG. 11 is a block diagram illustrating an example of a signal processing flow performed by the apparatus 100, according to embodiments. In embodiments, the apparatus 100 may include signal processing elements 1100 which may extract the changes in the received acoustic wave signals in order to assist in performing the proximity detection and proximity direction estimation. As can be seen in FIG. 11, the received acoustic wave signal 1101, illustrated as x(t) may be provided to a mixer 1102. The mixer 1102 may be mixed with or multiplied by a copy of the transmitted acoustic wave signal, for example the signal transmitted by the acoustic transmitter 110. In embodiments, the copy of the transmitted acoustic wave signal may be provided by a local oscillator 1103. The mixed signal output by the mixer 1102 may be provided to a low pass filter 1104, which may filter the mixed signal based on a cutoff frequency. The cutoff frequency may be selected to be above a maximum frequency of the interference pattern generated by the obstacle 200. In embodiments, the cutoff frequency may be for example about 100 Hz. The output of the low pass filter 1104 may be referred to as an envelope 1105 of the received acoustic wave signal, illustrated as Envelope(x(t)), and the signal processing performed by the signal processing elements 1100 may be referred to as signal mixing or coherent detection. In embodiments, the envelope 1105 may refer to the positive portion of the output of the low pass filter 1104. FIG. 12 shows a graph illustrating the envelope of a received acoustic wave signal due to an obstacle approaching, touching and retreating from the apparatus 100.

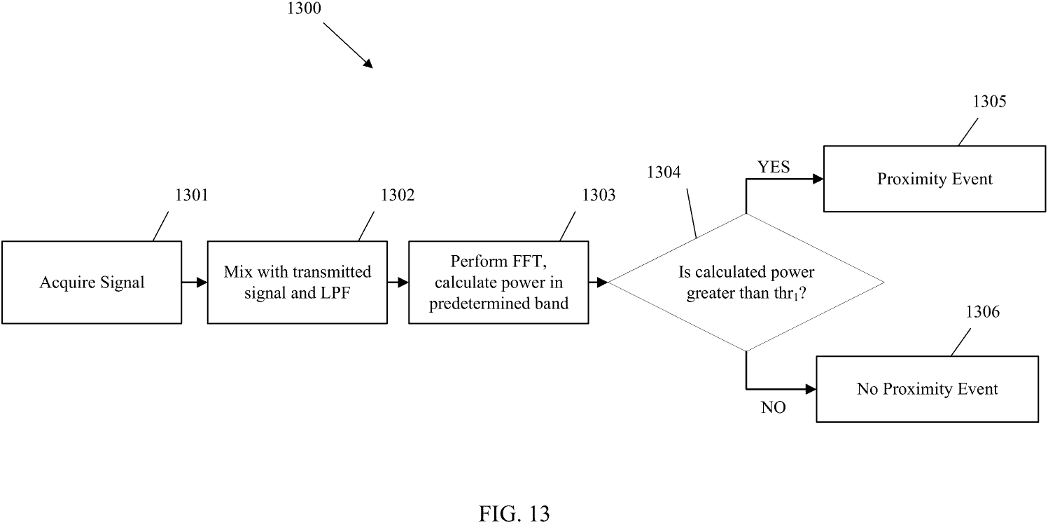

FIG. 13 is a flowchart illustrating an example process 1300 for detecting a proximity event corresponding to an obstacle, according to embodiments. The process 1300 may be performed by at least one processor using the apparatus 100 of FIG. 1A.

As shown in FIG. 13, in operation 1301, the process 1300 includes acquiring a signal. In embodiments, the acquired signal may correspond to the acoustic wave signal acquired using an acoustic receiver 120.

In operation 1302, the process 1300 includes mixing the acquired signal with a copy of the transmitted signal and applying a low pass filter in order to obtain an envelope of the acquired signal. In embodiments, operation 1302 may be performed by the signal processing elements 1100 discussed above.

In operation 1303 the process 1300 includes performing a fast Fourier transform on the envelope in order to calculate signal power of the signal in a predetermined band. In embodiments, the calculated signal power may be a sum of signal powers corresponding to frequencies below a cutoff frequency.

In operation 1304 the process 1300 includes determining whether the calculated power is greater than a first threshold value thr₁.

Based on determining that the calculated power is greater than the first threshold value thr₁ (YES at operation 1304), the process 1300 may proceed to operation 1305, in which a proximity event is determined to occur. For example, based on the calculated threshold being greater than the first threshold value thr₁, the at least one processor of the apparatus 100 may determine that an obstacle 200 is proximate to the apparatus 100.

Based on determining that the calculated power is not greater than the first threshold value thr₁ (NO at operation 1304), the process 1300 may proceed to operation 1306, in which a proximity event is determined to not to occur. In embodiments, the process 1300 may proceed to operation 1301, and the process 1300 may be performed again based on a signal acquired in a next signal window.

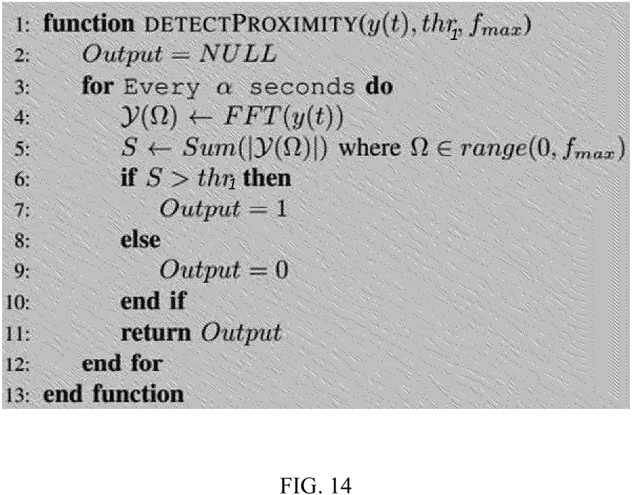

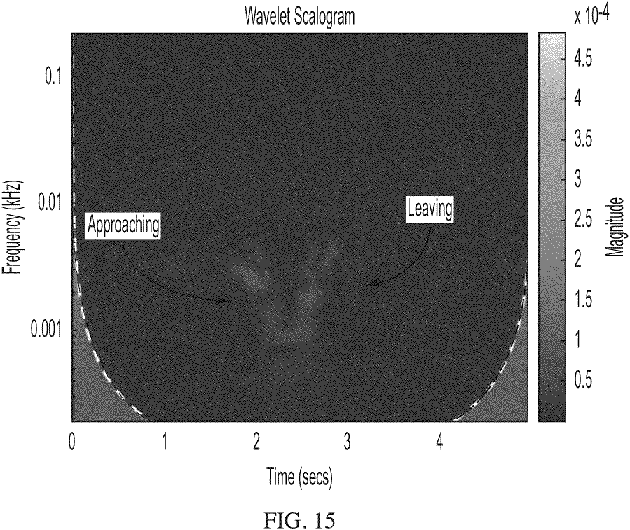

FIG. 14 illustrates an example proximity detection algorithm, according to embodiments. In embodiments, the proximity detection algorithm may correspond to process 1300 discussed above. As shown in FIG. 14, based on receiving an envelope y(t) corresponding to a signal window of α seconds, a fast Fourier transform is applied to the envelope y(t) to obtain signal powers Y corresponding to frequencies Ω below the cutoff frequency fₘₐₓ. If a sum S of the signal powers Y is a above the first threshold value thr₁, then the algorithm determines that a proximity has occurred (Output “1”). Otherwise, the algorithm determines that a proximity event has not occurred (Output “0”).

In embodiments, the process 1300 and the proximity detection algorithm discussed above may provide robust results based on a simple threshold value, for example first threshold value thr₁. In some embodiments, the first threshold value thr₁ may be set without needing to perform training, for example without using a machine learning approach which requires specific training for different objects, obstacles, and robot motion paths in order to work robustly. In embodiments, the first threshold value thr₁ may be calculated for a specific design, for example a specific design of a robot including the apparatus 100, and can then be used for all robots having the same design.

FIG. 15 is a wavelet scalogram corresponding to a received signal due to an obstacle approaching, touching and retreating from the apparatus 100, according to embodiments. Continuous Wavelet Transform plots may be analyzed to obtain frequencies present in the received signal. For example, FIG. 15 shows a plot in which the maximum frequency component that is present is 100 Hz. Therefore by considering the total power in the spectrum up to 100 Hz, the apparatus 100 can differentiate between proximity and no proximity. In embodiments, this process may be considered to be similar to classification but using only one feature - power in spectrum.

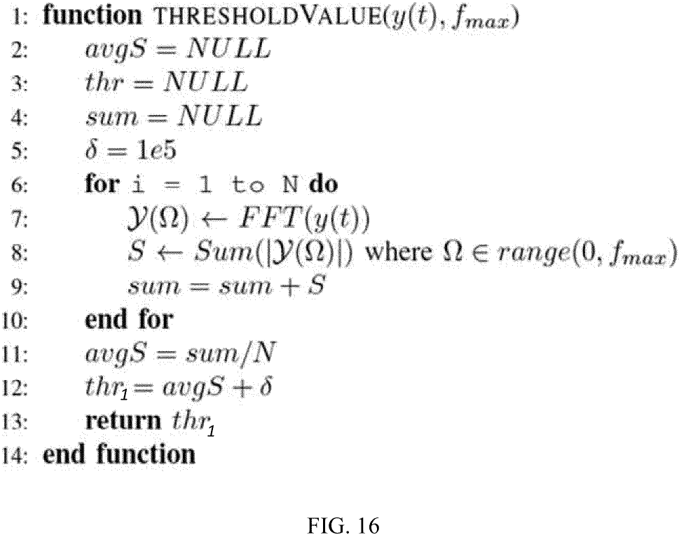

FIG. 16 illustrates an example threshold value calculation algorithm, according to embodiments. As shown in FIG. 16, based on receiving an envelope y(t), a fast Fourier transform is applied to the envelope y(t) to obtain signal powers Y corresponding to frequencies Ω below the cutoff frequency fₘₐₓ. Then an average avgS of the sum S may be found, and the first threshold value thr₁ may be set as the average avgS plus an offset δ.

As another example, in order to obtain a first threshold value thr₁ to be used in proximity detection, a power spectrum up to a particular cutoff frequency fₘₐₓ (for example 100 Hz) may be first observed when the robot is stationary and moving without any object in proximity. Then, a threshold value calculation algorithm, for example the threshold value calculation algorithm of FIG. 16, may be used to calculate the value of the power spectrum when the robot is stationary and in motion but no proximity occurs. Two threshold values, for example stationary threshold value thrₛ and moving threshold value thrₘ are obtained based on the threshold value calculation algorithm, and the threshold value may be determined by adding an offset δ to a higher value from among the two threshold values thrₛ and thrₘ, as shown in Equation 1 below:

$${\text{thr}}_{1} = \text{max} \left({\text{thr}}_{\text{s}} , {\text{thr}}_{\text{m}}\right) + δ \qquad \text{(Equation 1)}$$

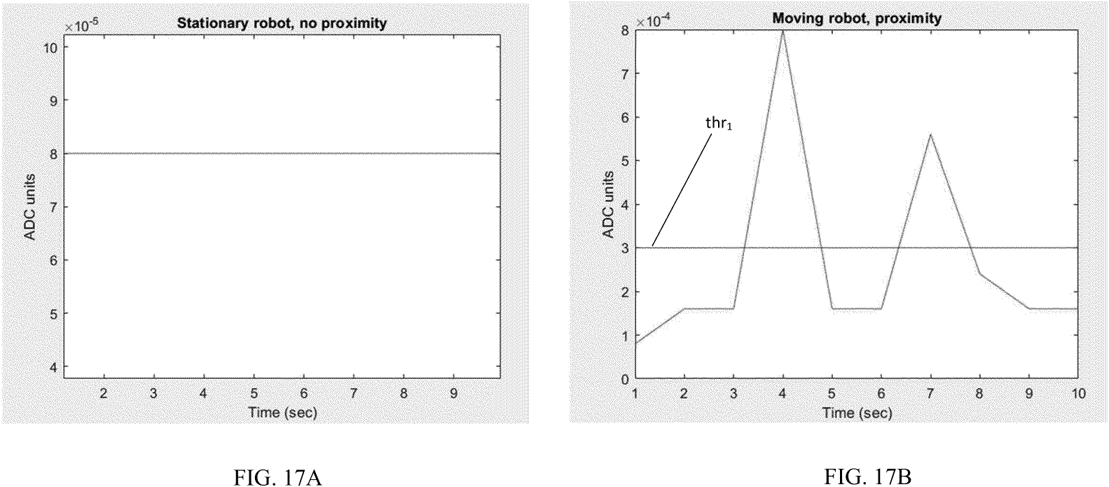

FIGS. 17A-17B illustrate example outputs of a proximity detection algorithm, according to embodiments. In particular, FIG. 17A illustrates sum S of the signal powers Y for a stationary robot with no obstacles in proximity, and FIG. 17B illustrates a sum S of the signal powers Y for a moving robot with two separate proximity events. Each peak which crosses the first threshold value thr₁ in FIG. 17B may correspond to a proximity event in which an obstacle is determined to be proximate to the apparatus 100.

In embodiments, in addition to providing proximity detection indicating whether an obstacle is proximate to the apparatus 100, the apparatus 100 may also be used to estimate a proximity direction of the obstacle with respect to the apparatus 100. For example, the first acoustic receiver 120a and the second acoustic receiver 120b may be deployed at different positions on the apparatus 100, for example on opposite sides of the apparatus 100. Then by comparing the signal strength of acoustic wave signals received by the first and second acoustic receivers 120a and 120b, the proximity direction can be estimated, for example by dividing the area surrounding the apparatus 100 into quadrants and indicating which quadrant the obstacle is present in. In embodiments, this estimated proximity direction can be used for collision avoidance, for example by providing a visual or audible signal, or by providing information about the estimated proximity direction to a controller such as a robot controller so that the robot controller can control the robot to avoid a collision with the obstacle.

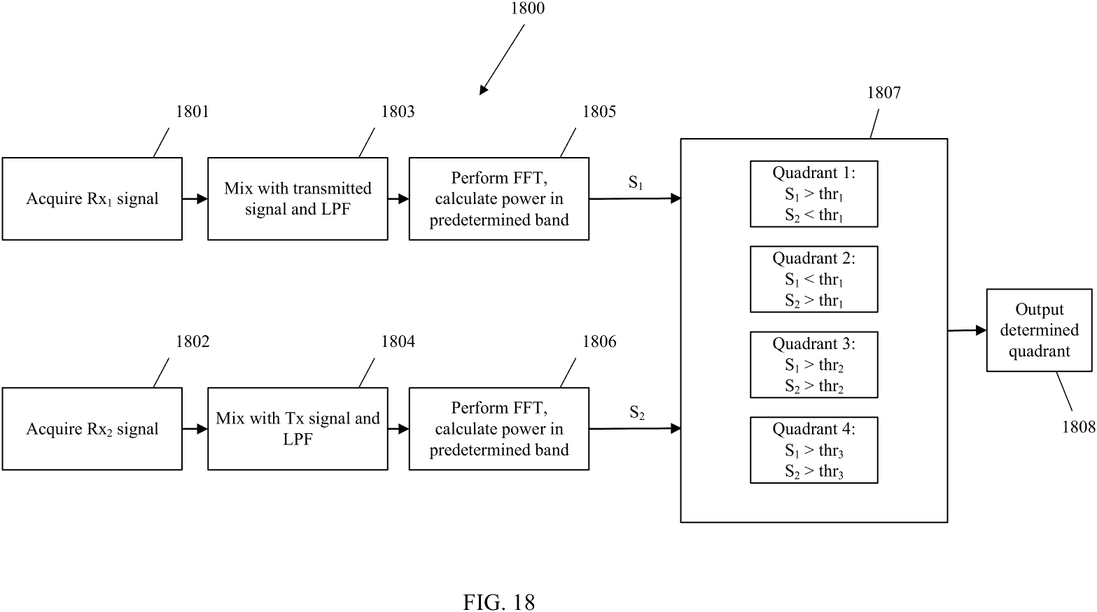

FIG. 18 is a flowchart illustrating an example process for estimating a relative proximity direction between an obstacle and the apparatus 100, according to embodiments. The process 1800 may be performed by at least one processor using the apparatus 100 of FIG. 1A.

As shown in FIG. 18, in operation 1801, the process 1800 includes acquiring a signal Rx₁. In embodiments, the signal Rx₁ may correspond to a first acoustic wave signal acquired using the first acoustic receiver 120a.

In operation 1802, the process 1800 includes acquiring a signal Rx₂. In embodiments, the signal Rx₂ may correspond to a second acoustic wave signal acquired using the second acoustic receiver 120b.

In operation 1803, the process 1800 includes mixing the signal Rx₁ with a copy of the transmitted signal and applying a low pass filter in order to obtain an envelope of the signal Rx₁. In embodiments, operation 1803 may be performed by the signal processing elements 1100 discussed above.

In operation 1804, the process 1800 includes mixing the signal Rx₂ with a copy of the transmitted signal and applying a low pass filter in order to obtain an envelope of the signal Rx₂. In embodiments, operation 1804 may be performed by the signal processing elements 1100 discussed above.

In operation 1805 the process 1800 includes performing a fast Fourier transform on the envelope corresponding to the signal Rx₁ in order to calculate a sum S₁ of the signal powers of the signal Rx₁ in a predetermined band.

In operation 1806 the process 1800 includes performing a fast Fourier transform on the envelope corresponding to the signal Rx₂ in order to calculate a sum S₂ of the signal powers of the signal Rx₂ in a predetermined band.

In operation 1807 the process 1800 includes determining a relative proximity direction of the obstacle based on the first threshold value thr₁, the second threshold value thr₂, and the third threshold value thr₃. In embodiments, based on the sum S₁ being greater than the first threshold value thr₁ and the sum S₂ being less than the first threshold value thr₁, the obstacle can be determined to be in quadrant 1. Based on the sum S₁ being less than the first threshold value thr₁ and the sum S₂ being greater than the first threshold value thr₁, the obstacle can be determined to be in quadrant 2. Based on both of the sum S₁ and the sum S₂ being greater than the second threshold value thr₂, the obstacle can be determined to be in quadrant 3. Based on both of the sum S₁ and the sum S₂ being greater than the third threshold value thr₃, the obstacle can be determined to be in quadrant 4.

In operation 1808 the process 1800 includes outputting the determined quadrant as the estimated proximity direction.

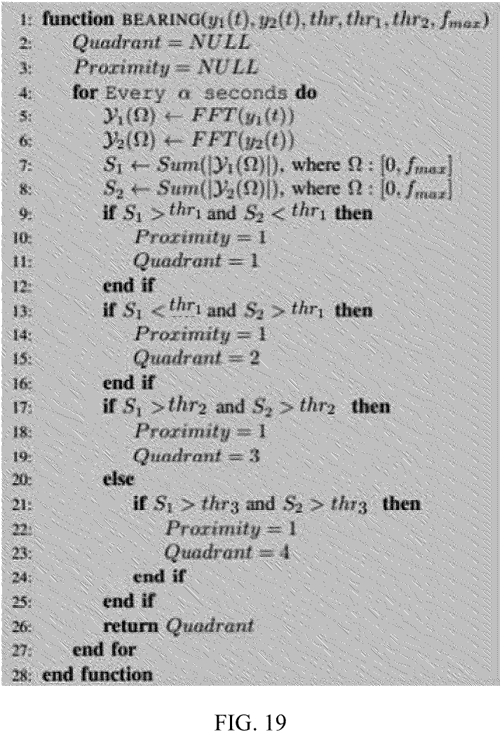

FIG. 19 illustrates an example proximity direction estimation algorithm, according to embodiments. In embodiments, the proximity direction detection algorithm may correspond to process 1800 discussed above. As shown in FIG. 19, based on receiving first envelope y₁(t) and a second envelope y₂(t) corresponding to a signal window of α seconds, a fast Fourier transform is applied to the first envelope y₁(t) and second envelope y₂(t) to obtain first signal powers Y₁ and second signal powers Y₂ corresponding to frequencies Ω below the cutoff frequency fₘₐₓ. If a sum S₁ of the first signal powers Y₁ is above the first threshold value thr₁ and a sum S₂ of the second signal powers Y₂ is below the first threshold value thr₁, then the algorithm determines that a proximity has occurred and that the proximate obstacle is located in quadrant 1 (Output “Proximity = 1” and “Quadrant = 1”). If the sum S₁ is below the first threshold value thr₁ and the sum S₂ is above the first threshold value thr₁, then the algorithm determines that a proximity has occurred and that the proximate obstacle is located in quadrant 2 (Output “Proximity = 1” and “Quadrant = 2”). If the sum S₁ and the sum S₂ are above the second threshold value thr₂, then the algorithm determines that a proximity has occurred and that the proximate obstacle is located in quadrant 3 (Output “Proximity = 1” and “Quadrant = 3”). If the sum S₁ and the sum S₂ are above the third threshold value thr₃, then the algorithm determines that a proximity has occurred and that the proximate obstacle is located in quadrant 4 (Output “Proximity = 1” and “Quadrant = 4”).

Although embodiments described above relate to proximity direction estimation based on thresholds, embodiments are not limited thereto. For example, in embodiments the proximity direction estimation may be performed by comparing received signals with each other, for example by comparing the signal Rx₁ with the signal Rx₁, or by comparing the sum S₁ with the sum S₂. In embodiments, comparing the received signals with each other instead of a reference signal or a threshold may provide improvements in one or more of cost, complexity, and accuracy.

In addition, although embodiments described above relate to proximity direction estimation having four quadrants, embodiments are not limited thereto. In embodiments, additional acoustic receivers 120 may be used in addition to the first and second acoustic receivers 120a and 120b. For example, two more acoustic receivers 120 may be added to the apparatus 100 and offset at 45 degrees on axis. In embodiments, different frequencies may be transmitted by the acoustic transmitter 110 and received by the acoustic receivers 120, which may provide a different interference pattern or a different ratio between receivers. In embodiments, a chirp signal may be used, and a signal reflected from the surroundings of the apparatus 100 may be analyzed, for example with a trained classifier, in order to determine a distance and location of an obstacle with respect to the apparatus 100. In embodiments, the classifier may be a neural network trained based on a dataset corresponding to the apparatus 100and various obstacles.

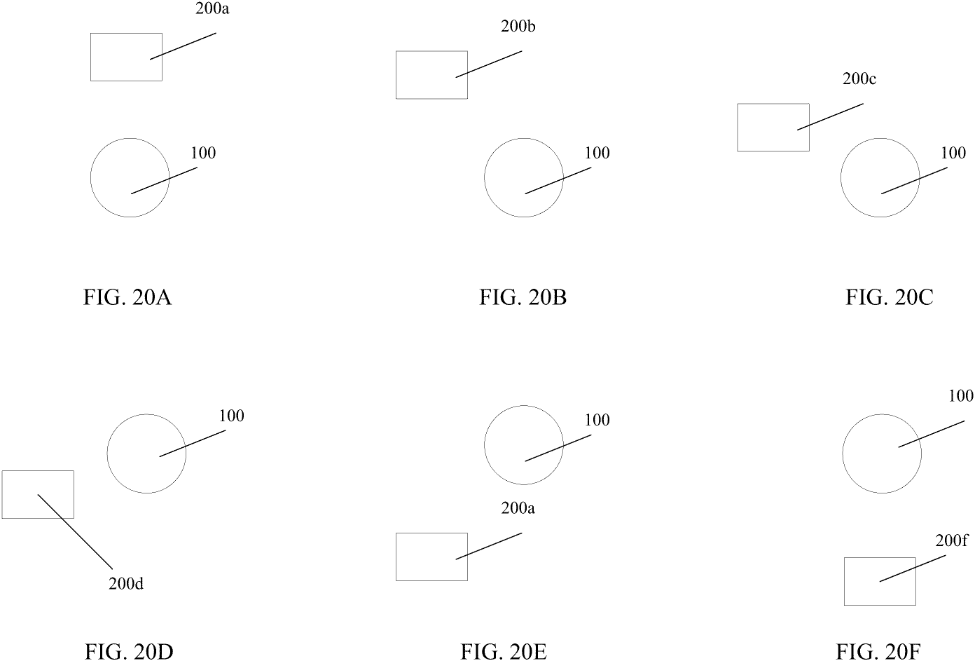

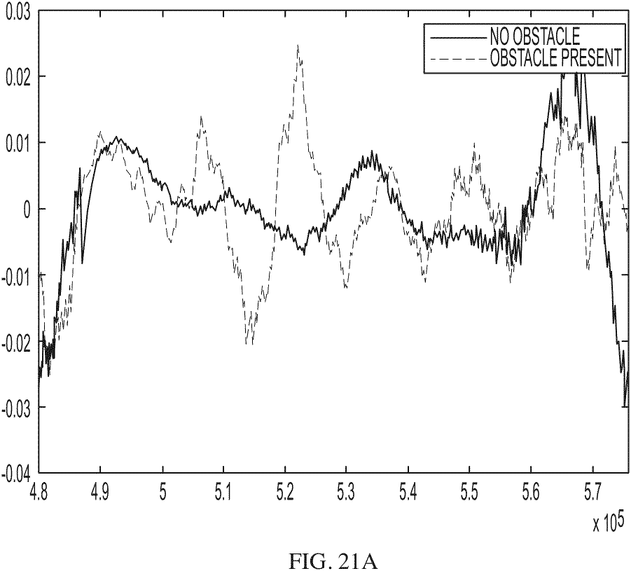

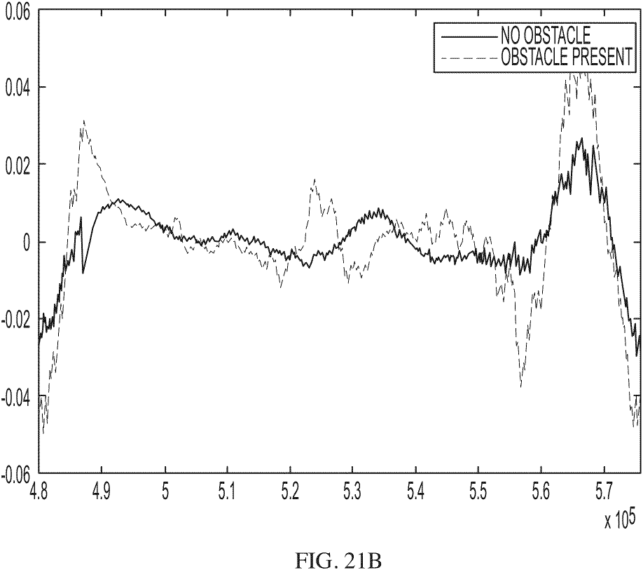

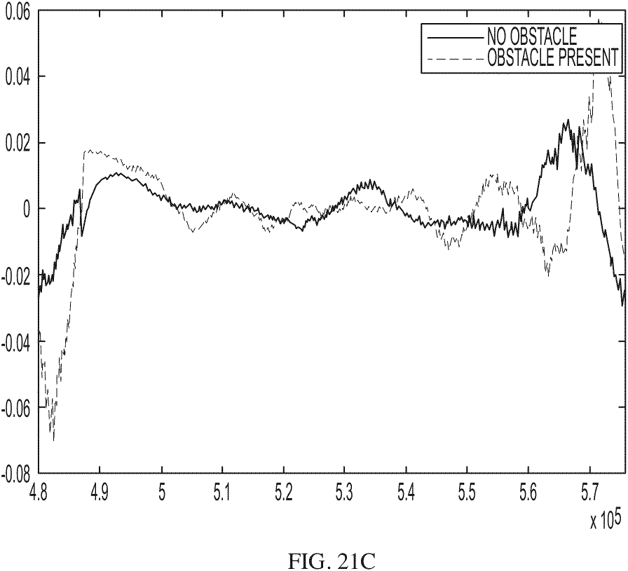

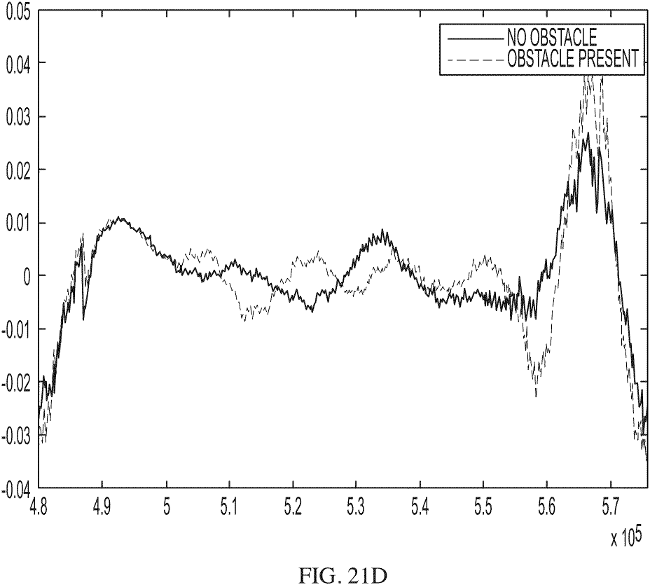

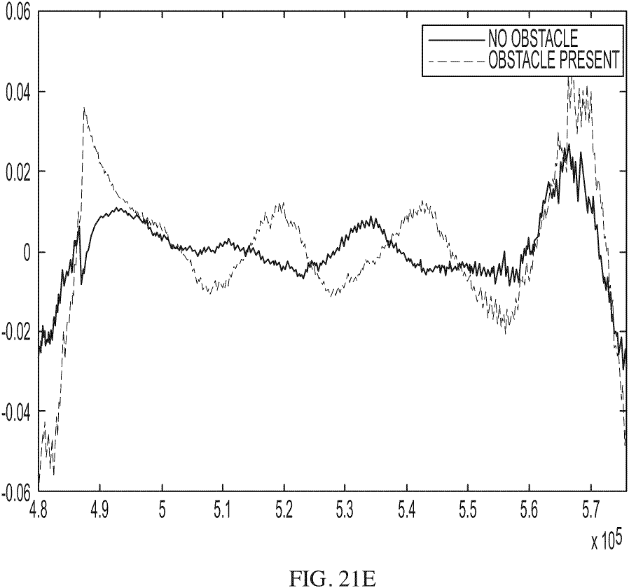

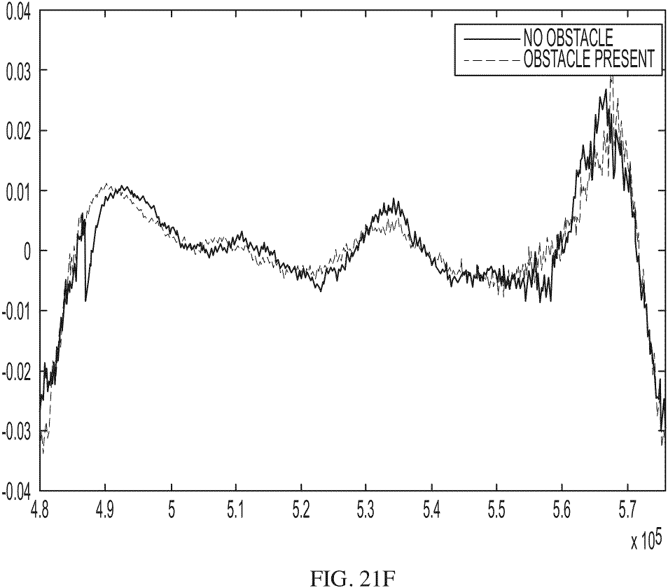

FIGS. 20A-20F are diagrams illustrating obstacles at various positions with respect to the apparatus 100, according to embodiments, and FIGS. 21A-21Fshow graphs illustrating received signals due to the obstacle located at various positions with respect to the apparatus 100. In particular, the graphs of FIGS. 21A-21F may show signals received by a single acoustic receiver 120 based on a chirp signal transmitted from a single acoustic transmitter 110, as compared to the signals received when no obstacles are present.

For example, the graph of FIG. 21A shows a received signal when obstacle 200a is present compared to a received signal received when no obstacles are present, the graph of FIG. 21B shows a received signal when obstacle 200b is present compared to a received signal received when no obstacles are present, the graph of FIG. 21C shows a received signal when obstacle 200c is present compared to a received signal received when no obstacles are present, the graph of FIG. 21D shows a received signal when obstacle 200d is present compared to a received signal received when no obstacles are present, the graph of FIG. 21E shows a received signal when obstacle 200e is present compared to a received signal received when no obstacles are present, and the graph of FIG. 21F shows a received signal when obstacle 200f is present compared to a received signal received when no obstacles are present.

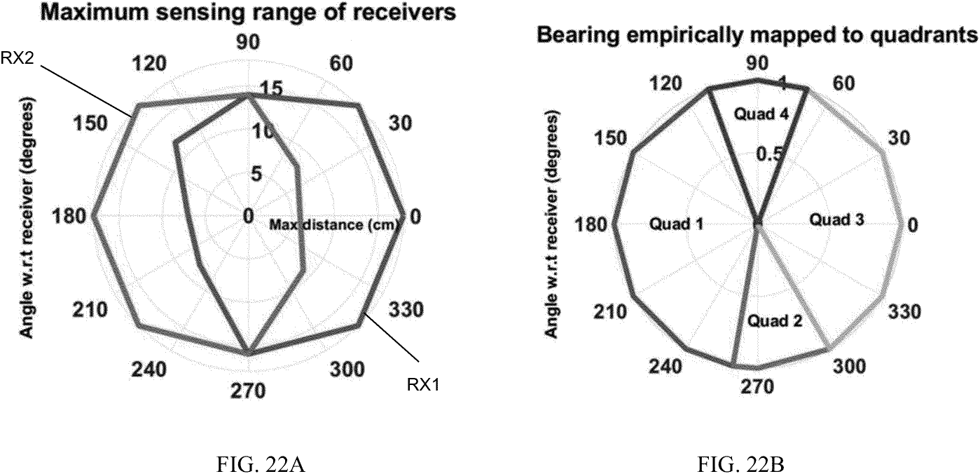

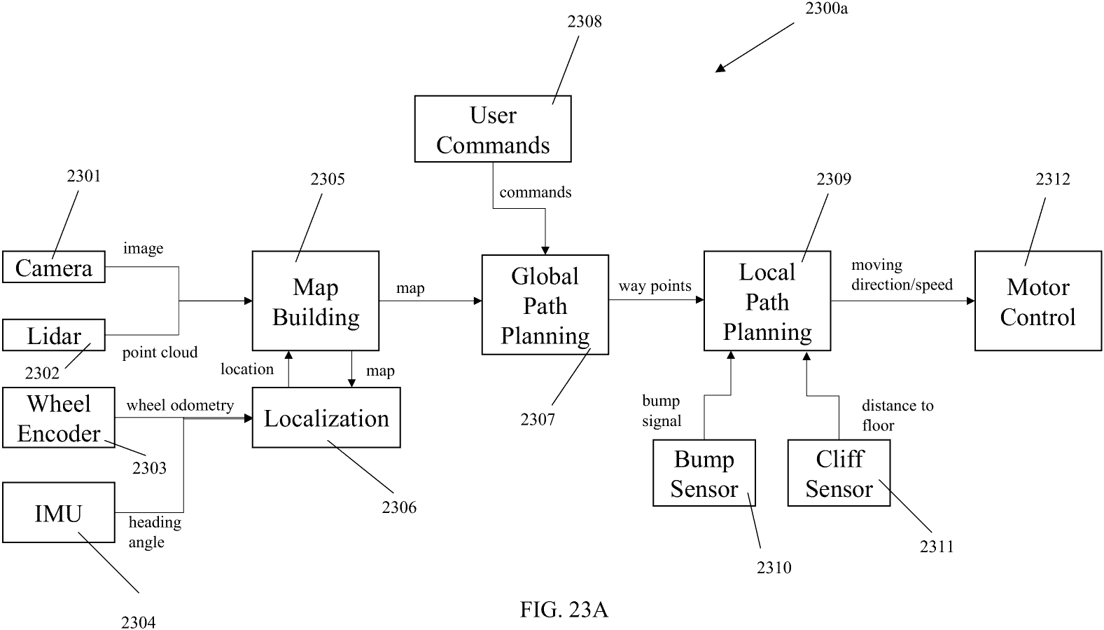

FIGS. 22A-22B illustrate example results of proximity detection and proximity direction estimation corresponding to the apparatus 100. In particular, FIG. 22A shows examples of sensing ranges of first acoustic receiver 120a and second acoustic receiver 120b, and FIG. 22B shows examples of proximity directions mapped to quadrant 1 through quadrant 4. Embodiments described herein may provide 100% true positive rate (TPR) and 100% true negative rate (TNR) for a stationary object, and 94% TPR and 96.6% TNR for moving object.

However, these are only examples and embodiments are not limited to the ranges and proximity direction illustrated in FIGS. 22A-22B.

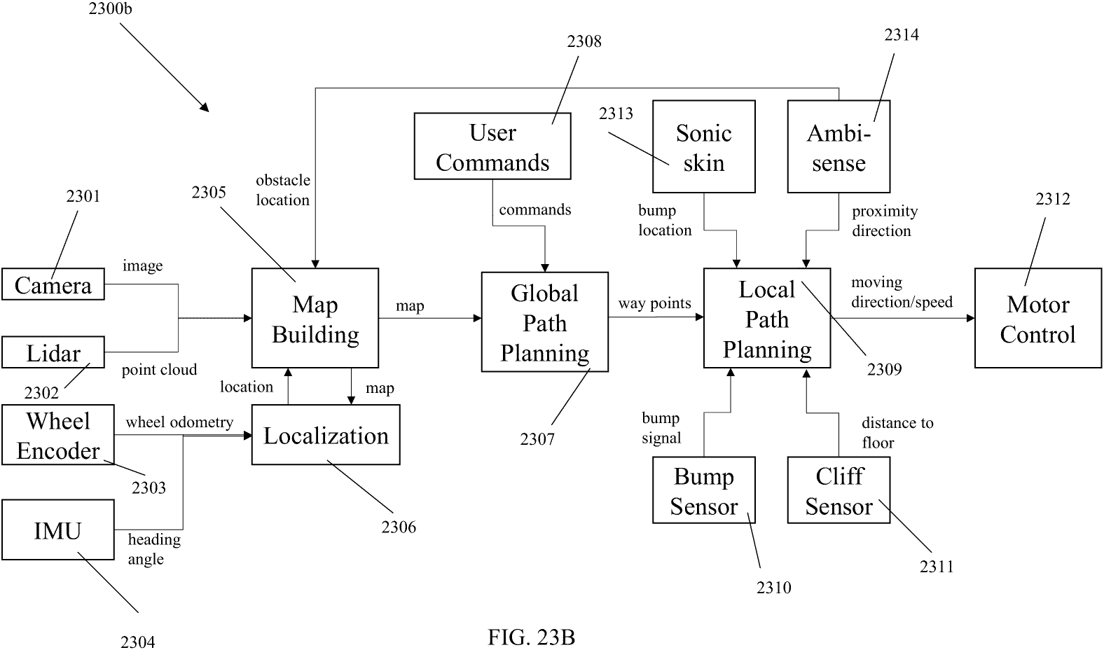

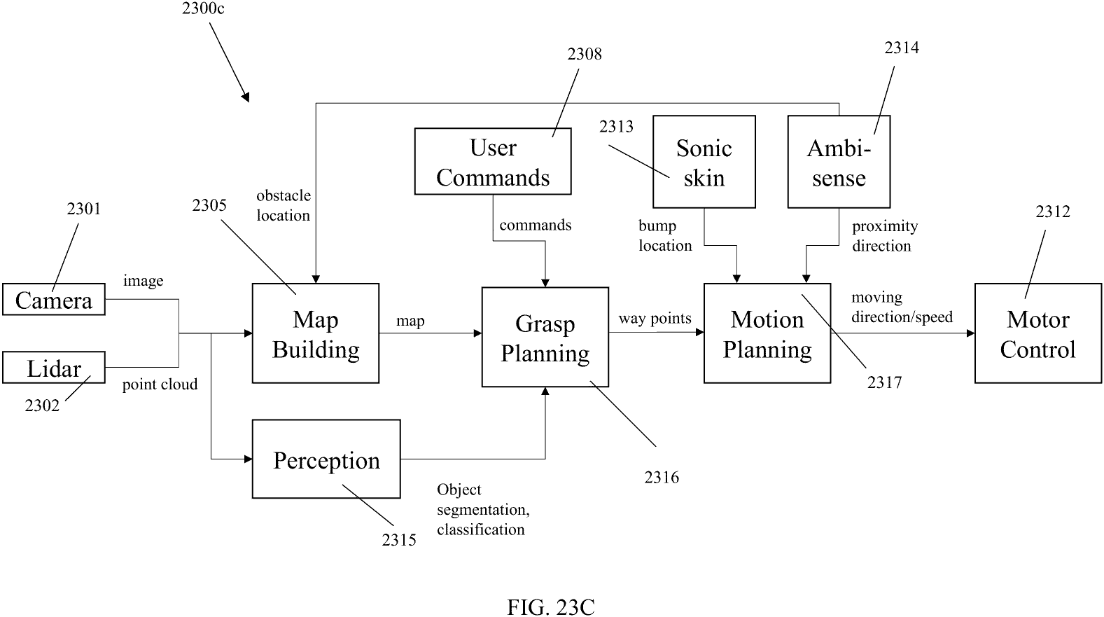

FIG. 23A is a block diagram of an example robot control system 2300a, according to embodiments. In embodiments, the robot control system 2300a may be used to control, for example, a robotic vacuum cleaner. As shown in FIG. 23a, robot control system 2300a includes sensors such as a camera 2301, a laser imaging, detection, and ranging (LIDAR) unit 2302, a wheel encoder 2303, an inertial measurement unit (IMU) 2304, a bump sensor 2310, and a cliff sensor 2311.

A localization unit 2306 may receive wheel odometry information from the wheel encoder 2303 and a heading angle from the IMU 2304, and may provide location information to a map building unit 2305.

The map building unit 2305 may receive images from the camera 2301, a point cloud from the LIDAR unit 2302, and the location information, and may provide map information to the localization unit 2306 and a global path planning unit 2307.

The global path planning unit 2307 may receive the map information and user commands from user interface 2308, and may provide way points to a local path planning unit 2309.

The local path planning unit 2309 may receive a bump signal from the bump sensor 2310, a floor distance from the cliff sensor 2311, and the way points, and may provide a desired moving direction and speed to a motor control unit 2312, which may control a motion of, for example the robotic vacuum cleaner.

Accordingly, the robot control system 2300a may control a robotic vacuum cleaner. However, because proximity detection may be primarily provided by the bump sensor 2310, and because the bump sensor may not provide detailed information about a detection of an obstacle within a certain proximity, or a proximity direction of a detected obstacle, the robotic vacuum cleaner may become easily stuck.

FIG. 23B is a block diagram of an example robot control system 2300b which incorporates the apparatus 100, according to embodiments. In embodiments, the robot control system 2300b may be used to control, for example, a robotic vacuum cleaner. In particular, the robot control system 2300b may be similar to the robot control system 2300a, and may also include a sonic skin unit 2313, which may provide bump location information to the local path planning unit 2309, and an ambi-sense unit 2314, which may provide proximity direction information to the local path planning unit 2309. The ambi-sense unit 2314 may be a proximity detection and proximity direction estimation system in accordance with embodiments. In embodiments, the ambi-sense unit 2314 may correspond to the apparatus 100, and the proximity direction information may correspond to the proximity detection and proximity direction estimation described above.

Because the robot control system 2300b includes the ambi-sense unit 2314, when a bump occurs between the robotic vacuum cleaner and an obstacle, the robot control system 2300b may control the robotic vacuum cleaner to turn to free space. In addition, in the case of moving obstacles, the robot control system 2300b may determine where the obstacle is, or is from, so the robot control system 2300b can either ignore if the obstacle is moving away, detour motion if the obstacle is in the way and there is an alternate path to the goal, slow down the speed of the robotic vacuum cleaner if the obstacle is too close to the desired path, and stop the robotic vacuum cleaner if the obstacle is on the desired path and there is no way to detour. In addition, the proximity direction information may be used to more accurately build a map.

FIG. 23C is a block diagram of an example robot control system 2300b which incorporates the apparatus 100, according to embodiments. In embodiments, the robot control system 2300c may be used to control, for example, a robotic arm. In particular, the robot control system 2300c may be similar to the robot control system 2300b, and may also include a perception unit 2315, which may provide object segmentation and classification to a grasp-planning unit 2316. The grasp-planning unit 2316 may provide way points to a motion planning unit 2317, which may receive bump location information from the sonic skin unit 2313 and proximity direction information from the ambi-sense unit 2314, and may provide a desired moving direction and speed to the motor control unit 2312, which may control a motion of, for example the robotic arm. As discussed above, the ambi-sense unit 2314 may be a proximity detection and proximity direction estimation system in accordance with embodiments. In embodiments, the ambi-sense unit 2314 may correspond to the apparatus 100, and the proximity direction information may correspond to the proximity detection and proximity direction estimation described above.

Because the robot control system 2300c includes the ambi-sense unit 2314, in the case of an unexpected bump or dynamic scene, the robot control system 2300c may determine where the obstacle is, or is from, so the robot control system 2300b can either ignore if the obstacle is moving away, detour motion if the obstacle is in the way and there is an alternate path to the goal, slow down the speed of the robotic arm if the obstacle is too close to the desired path, and stop the robotic arm if the obstacle is on the desired path and there is no way to detour. In addition, the proximity direction information may be used to more accurately build a map.

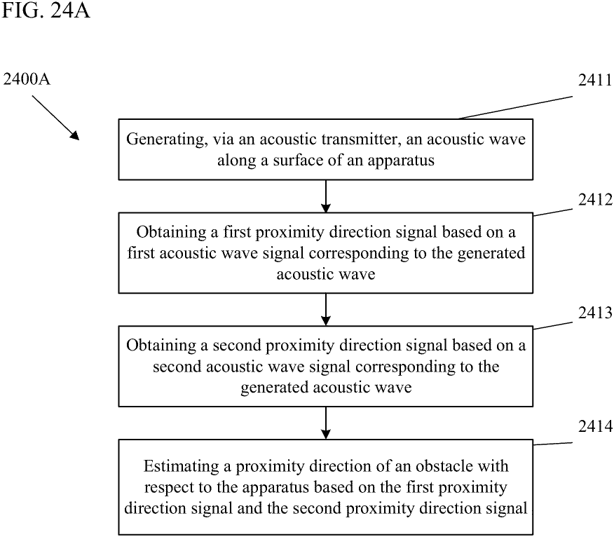

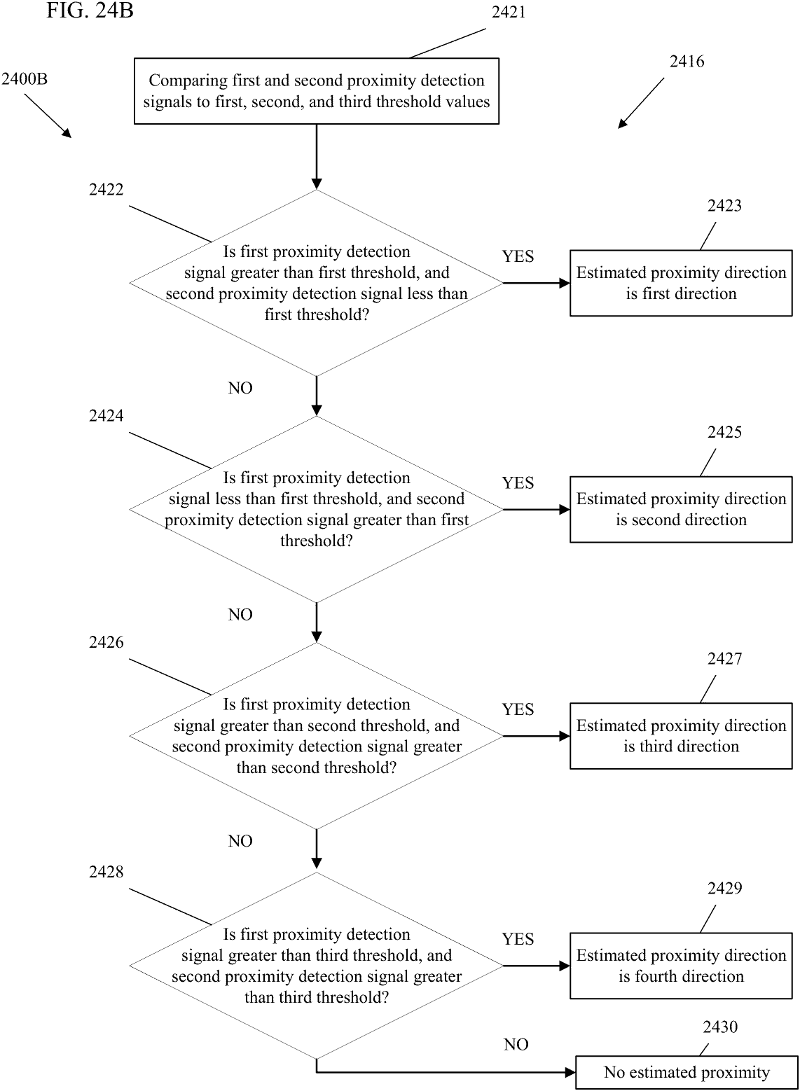

FIGS. 24A-24B are flowcharts of processes 2400A and 2400B for proximity detection and proximity direction estimation, according to embodiments. The processes 2400A and 2400B may be performed by at least one processor using the apparatus 100 of FIG. 1A.

As shown in FIG. 24A, in operation 2411, the process 2400A includes generating, via an acoustic transmitter disposed on a surface of an apparatus, an acoustic wave along the surface. In embodiments, the acoustic transmitter may correspond to the acoustic transmitter 110, and the apparatus may correspond to the apparatus 100.

In operation 2412, the process 2400A includes receiving, via a first acoustic receiver, a first acoustic wave signal corresponding to the generated acoustic wave. In embodiments, the first acoustic receiver may be spaced apart from the surface. In embodiments, the first acoustic receiver may correspond to the first acoustic receiver 120a.

In operation 2413, the process 2400a includes receiving, via a second acoustic receiver, a second acoustic wave signal corresponding to the generated acoustic wave. In embodiments, the second acoustic receiver may be spaced apart from the surface, and a position of the second acoustic receiver may be different from a position of the first acoustic receiver with respect to the apparatus. In embodiments, the second acoustic receiver may correspond to the second acoustic receiver 120b.

In operation 2414, the process 2400a includes estimating a proximity direction of an obstacle with respect to apparatus based on the first proximity direction signal and the second proximity direction signal.

In embodiments, the first acoustic receiver and the second acoustic receiver may be attached to the surface at two opposing positions on the surface, and may be spaced apart from the surface by a same distance.

In embodiments, the acoustic transmitter may include a piezoelectric transmitter, the first acoustic receiver may include a first piezoelectric receiver, and the second acoustic receiver may include a second piezoelectric receiver.

In embodiments, the first proximity direction signal may be obtained by applying signal processing to the first acoustic wave signal, the second proximity direction signal may be obtained by applying signal processing to the second acoustic wave signal, and the applying of the signal processing may include applying at least one from among a low-pass filter (LPF) and a fast Fourier transform (FFT).

In embodiments, the apparatus may include a first connection structure and a second connection structure, a first end of the first connection structure may be connected to the first acoustic receiver, a second end of the first connection structure may be connected to the surface, such that the first acoustic receiver is spaced apart from the surface by a first distance, and a first end of the second connection structure may be connected to the second acoustic receiver, and a second end of the second connection structure is connected to the surface, such that the second acoustic receiver is spaced apart from the surface by the first distance.

In embodiments, the first connection structure may be configured to reduce an effect of vibrations transmitted mechanically through the first object on the first acoustic wave signal received by the first acoustic receiver, and the second connection structure may be configured to reduce an effect of the vibrations on the second acoustic wave signal received by the second acoustic receiver.

In embodiments, the acoustic wave generated by the acoustic transmitter may include a chirp signal, and estimating of the proximity direction may further include providing the first proximity direction signal and the second proximity direction signal to a neural network which is trained based on a dataset corresponding to the electronic device and a plurality of obstacles.

As shown in FIG. 24B, in operation 2421, the process 2400B includes comparing the first and second proximity detection signals to first, second, and third threshold values.

In operation 2422, the process 2400B includes determining whether the first proximity detection signal is greater than the first threshold and the second proximity detection signal is less than the first threshold.

Based on the first proximity detection signal being greater than the first threshold and the second proximity detection signal being less than the first threshold (YES at operation 2422), the process 2400B may proceed to operation 2423, in which the estimated proximity direction is determined to be a first direction. Otherwise (NO at operation 2422), the process 2400B may proceed to operation 2424.

In operation 2424, the process 2400B includes determining whether the first proximity detection signal is less than the first threshold and the second proximity detection signal is greater than the first threshold.

Based on the first proximity detection signal being less than the first threshold and the second proximity detection signal being greater than the first threshold (YES at operation 2424), the process 2400B may proceed to operation 2425, in which the estimated proximity direction is determined to be a second direction. Otherwise (NO at operation 2422), the process 2400B may proceed to operation 2426.

In operation 2426, the process 2400B includes determining whether the first and second proximity detection signals are greater than the second threshold.

Based on the first and second proximity detection signals being greater than the second threshold (YES at operation 2426), the process 2400B may proceed to operation 2427, in which the estimated proximity direction is determined to be a third direction. Otherwise (NO at operation 2426), the process 2400B may proceed to operation 2428.

In operation 2428, the process 2400B includes determining whether the first and second proximity detection signals are greater than the third threshold.

Based on the first and second proximity detection signals being greater than the third threshold (YES at operation 2428), the process 2400B may proceed to operation 2429, in which the estimated proximity direction is determined to be a fourth direction. Otherwise (NO at operation 2422), the process 2400B may proceed to operation 2430, in which no estimated proximity is determined.

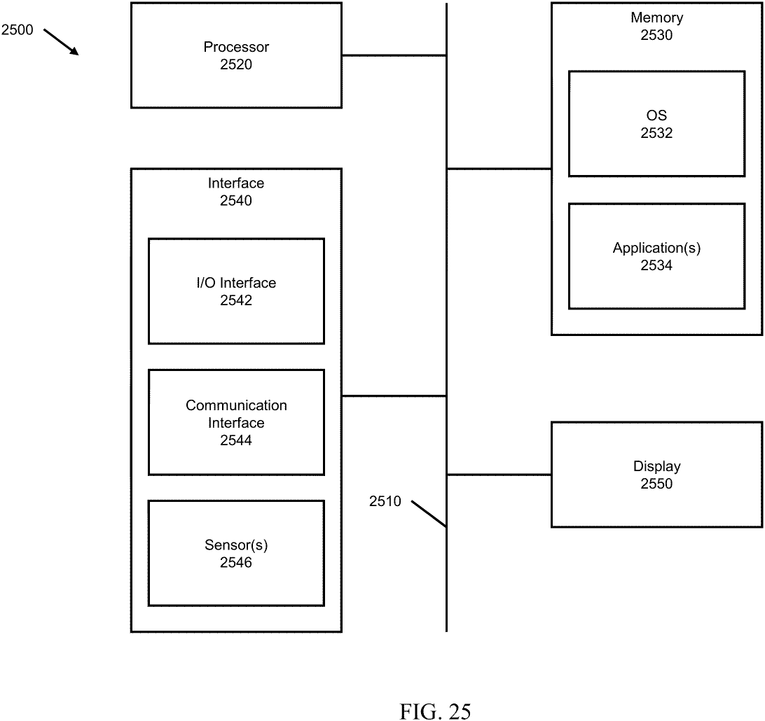

FIG. 25 is a block diagram of an electronic device 2500 in which the apparatus 100 of FIGS. 1A and 1B is implemented, according to embodiments.

FIG. 25 is for illustration only, and other embodiments of the electronic device 2500 could be used without departing from the scope of this disclosure.

The electronic device 2500 includes a bus 2510, a processor 2520, a memory 2530, an interface 2540, and a display 2550.

The bus 2510 includes a circuit for connecting the components 2520 to 2550 with one another. The bus 2510 functions as a communication system for transferring data between the components 2520 to 2550 or between electronic devices.

The processor 2520 includes one or more of a central processing unit (CPU), a graphics processor unit (GPU), an accelerated processing unit (APU), a many integrated core (MIC), a field-programmable gate array (FPGA), or a digital signal processor (DSP). The processor 2520 is able to perform control of any one or any combination of the other components of the electronic device 2500, and/or perform an operation or data processing relating to communication. The processor 2520 executes one or more programs stored in the memory 2530.

The memory 2530 may include a volatile and/or non-volatile memory. The memory 2530 stores information, such as one or more of commands, data, programs (one or more instructions), applications 2534, etc., which are related to at least one other component of the electronic device 2500 and for driving and controlling the electronic device 2500. For example, commands and/or data may formulate an operating system (OS) 2532. Information stored in the memory 2530 may be executed by the processor 2520.

The applications 2534 include the above-discussed embodiments. These functions can be performed by a single application or by multiple applications that each carry out one or more of these functions.

The display 2550 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 2550 can also be a depth-aware display, such as a multi-focal display. The display 2550 is able to present, for example, various contents, such as text, images, videos, icons, and symbols.

The interface 2540 includes input/output (I/O) interface 2542, communication interface 2544, and/or one or more sensors 2546. The I/O interface 2542 serves as an interface that can, for example, transfer commands and/or data between a user and/or other external devices and other component(s) of the electronic device 2500.

The sensor(s) 2546 can meter a physical quantity or detect an activation state of the electronic device 2500 and convert metered or detected information into an electrical signal. For example, the sensor(s) 2546 can include one or more cameras or other imaging sensors for capturing images of scenes. The sensor(s) 2546 can also include any one or any combination of a microphone, a keyboard, a mouse, one or more buttons for touch input, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, and a fingerprint sensor. The sensor(s) 2546 can further include an inertial measurement unit. In addition, the sensor(s) 2546 can include a control circuit for controlling at least one of the sensors included herein. Any of these sensor(s) 2546 can be located within or coupled to the electronic device 2500. The sensors 2546 may be used to detect touch input, gesture input, and hovering input, using an electronic pen or a body portion of a user, etc.

The communication interface 2544, for example, is able to set up communication between the electronic device 2500 and an external electronic device. The communication interface 2544 can be a wired or wireless transceiver or any other component for transmitting and receiving signals.

The embodiments of the disclosure described above may be written as computer executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to the electronic device 2200, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The above described method may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of the server.

A model related to the CNN described above may be implemented via a software module. When the CNN model is implemented via a software module (for example, a program module including instructions), the CNN model may be stored in a computer-readable recording medium.

Also, the CNN model may be a part of the apparatus 100 described above by being integrated in a form of a hardware chip. For example, the CNN model may be manufactured in a form of a dedicated hardware chip for artificial intelligence, or may be manufactured as a part of an existing general-purpose processor (for example, a CPU or application processor) or a graphic-dedicated processor (for example a GPU).

Also, the CNN model may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server of the manufacturer or electronic market, or a storage medium of a relay server.

Accordingly, embodiments may relate to a novel sensing architecture that may enable robots and other objects to sense proximity and proximity direction of surrounding obstacles. Embodiments may use low-cost piezoelectric transducers that produce and receive emanated surface waves as a sensory signal. Embodiments may provide a novel receiver structure that provides clean and sensitive signals, along with a new signal processing pipeline and several simple but elegant detection algorithms. As a result, embodiments may enable responsive human robot interaction, provide robots with collision detection and avoidance capabilities when obstacles are in proximity, make robots that move more aware of surroundings, enable path planning for robots in a dynamic environment, and allow robots and humans to share environments more freely.

While the embodiments of the disclosure have been described with reference to the figures, it will be understood by those of ordinary skill in the art that various changes in form and details may be made therein without departing from the spirit and scope as defined by the following claims.

What is claimed is:

1. An apparatus for estimating a proximity direction of an obstacle, the apparatus comprising:
an acoustic transmitter attached to a surface of the apparatus;
a first acoustic receiver spaced apart from the surface of the apparatus;
a second acoustic receiver spaced apart from the surface of the apparatus, wherein a position of the second acoustic receiver is different from a position of the first acoustic receiver with respect to the apparatus;
a memory configured to store instructions; and
at least one processor configured to execute the instructions to:
control the acoustic transmitter to generate an acoustic wave along the surface;
obtain a first proximity direction signal based on first acoustic wave signal received via the first acoustic receiver, the first acoustic wave signal corresponding to the generated acoustic wave;
obtain a second proximity direction signal based on a second acoustic wave signal received via the second acoustic receiver, the second acoustic wave signal corresponding to the generated acoustic wave; and
estimate the proximity direction of the obstacle with respect to the apparatus based on the first proximity direction signal and the second proximity direction signal.

2. The apparatus of claim 1, wherein the first acoustic receiver and the second acoustic receiver are attached to the surface at two opposing positions on the surface, and are spaced apart from the surface by a same distance.

3. The apparatus of claim 1, wherein the acoustic transmitter comprises a piezoelectric transmitter,
wherein the first acoustic receiver comprises a first piezoelectric receiver, and
wherein the second acoustic receiver comprises a second piezoelectric receiver.

4. The apparatus of claim 1, wherein the first proximity direction signal is obtained by applying signal processing to the first acoustic wave signal,
wherein the second proximity direction signal is obtained by applying signal processing to the second acoustic wave signal, and
wherein the signal processing comprises at least one from among a low-pass filter (LPF) and a fast Fourier transform (FFT).

5. The apparatus of claim 1, further comprising a first connection structure and a second connection structure,
wherein a first end of the first connection structure is connected to the first acoustic receiver, and a second end of the first connection structure is connected to the surface, such that the first acoustic receiver is spaced apart from the surface by a first distance, and
wherein a first end of the second connection structure is connected to the second acoustic receiver, and a second end of the second connection structure is connected to the surface, such that the second acoustic receiver is spaced apart from the surface by the first distance.

6. The apparatus of claim 5, wherein the first connection structure is configured to reduce an effect of vibrations transmitted mechanically through the apparatus on the first acoustic wave signal received by the first acoustic receiver, and
wherein the second connection structure is configured to reduce an effect of the vibrations on the second acoustic wave signal received by the second acoustic receiver.

7. The apparatus of claim 1, wherein to estimate the proximity direction, the at least one processor is further configured to execute the instructions to:
compare the first proximity direction signal and the second proximity direction signal to a first threshold value, a second threshold value, and a third threshold value,
based on the first proximity direction signal being greater than the first threshold value and the second proximity direction signal being less than the first threshold value, estimate the proximity direction to be a first direction,
based on the first proximity direction signal being less than the first threshold value and the second proximity direction signal being greater than the first threshold value, estimate the proximity direction to be a second direction,
based on the first proximity direction signal being greater than the second threshold value and the second proximity direction signal being greater than the second threshold value, estimate the proximity direction to be a third direction, and
based on the first proximity direction signal being greater than the third threshold value and the second proximity direction signal being greater than the third threshold value, estimate the proximity direction to be a fourth direction.

8. The apparatus of claim 1, wherein the acoustic wave generated by the acoustic transmitter comprises a chirp signal, and
wherein the at least one processor is further configured to estimate the proximity direction by providing the first proximity direction signal and the second proximity direction signal to a neural network which is trained based on a dataset corresponding to the apparatus and a plurality of obstacles.

9. A method for estimating a proximity direction of an obstacle, the method being executed by at least one processor and comprising:
controlling an acoustic transmitter attached to a surface of an electronic device to generate an acoustic wave along the surface;
obtaining a first proximity direction signal based on a first acoustic wave signal received via a first acoustic receiver spaced apart from the surface of the electronic device, wherein the first acoustic wave signal corresponds to the generated acoustic wave;
obtaining a second proximity direction signal based on a second acoustic wave signal received via a second acoustic receiver spaced apart from the surface of the electronic device, wherein a position of the second acoustic receiver is different from a position of the first acoustic receiver with respect to the electronic device, and wherein the second acoustic wave signal corresponds to the generated acoustic wave; and
estimating the proximity direction of the obstacle with respect to the electronic device based on the first proximity direction signal and the second proximity direction signal.

10. The method of claim 9, wherein the first acoustic receiver and the second acoustic receiver are attached to the surface at two opposing positions on the surface, and are spaced apart from the surface by a same distance.

11. The method of claim 9, wherein the acoustic transmitter includes a piezoelectric transmitter,
wherein the first acoustic receiver includes a first piezoelectric receiver, and
wherein the second acoustic receiver includes a second piezoelectric receiver.

12. The method of claim 9, wherein the first proximity direction signal is obtained by applying signal processing to the first acoustic wave signal,
wherein the second proximity direction signal is obtained by applying signal processing to the second acoustic wave signal, and
wherein the applying of the signal processing comprises applying at least one from among a low-pass filter (LPF) and a fast Fourier transform (FFT).

13. The method of claim 9, wherein the electronic device includes a first connection structure and a second connection structure,
wherein a first end of the first connection structure is connected to the first acoustic receiver, and a second end of the first connection structure is connected to the surface, such that the first acoustic receiver is spaced apart from the surface by a first distance, and
wherein a first end of the second connection structure is connected to the second acoustic receiver, and a second end of the second connection structure is connected to the surface, such that the second acoustic receiver is spaced apart from the surface by the first distance.

14. The method of claim 13, wherein the first connection structure is configured to reduce an effect of vibrations transmitted mechanically through the electronic device on the first acoustic wave signal received by the first acoustic receiver, and
wherein the second connection structure is configured to reduce an effect of the vibrations on the second acoustic wave signal received by the second acoustic receiver.

15. The method of claim 9, wherein the estimating of the proximity direction comprises:
comparing the first proximity direction signal and the second proximity direction signal to a first threshold value, a second threshold value, and a third threshold value,
based on the first proximity direction signal being greater than the first threshold value and the second proximity direction signal being less than the first threshold value, estimating the proximity direction to be a first direction,
based on the first proximity direction signal being less than the first threshold value and the second proximity direction signal being greater than the first threshold value, estimating the proximity direction to be a second direction,
based on the first proximity direction signal being greater than the second threshold value and the second proximity direction signal being greater than the second threshold value, estimating the proximity direction to be a third direction, and
based on the first proximity direction signal being greater than the third threshold value and the second proximity direction signal being greater than the third threshold value, estimating the proximity direction to be a fourth direction.

16. The method of claim 9, wherein the acoustic wave generated by the acoustic transmitter comprises a chirp signal, and
wherein the estimating of the proximity direction further comprises providing the first proximity direction signal and the second proximity direction signal to a neural network which is trained based on a dataset corresponding to the electronic device and a plurality of obstacles.

17. A non-transitory computer-readable storage medium storing instructions that, when executed by at least one processor of an electronic device for estimating a proximity direction of an obstacle, cause the at least one processor to:
control an acoustic transmitter attached to a surface of an electronic device to generate an acoustic wave along the surface;
obtain a first proximity direction signal based on a first acoustic wave signal received via a first acoustic receiver spaced apart from the surface of the electronic device, wherein the first acoustic wave signal corresponds to the generated acoustic wave;
obtain a second proximity direction signal based on a second acoustic wave signal received via a second acoustic receiver spaced apart from the surface of the electronic device, wherein a position of the second acoustic receiver is different from a position of the first acoustic receiver with respect to the electronic device, and wherein the second acoustic wave signal corresponds to the generated acoustic wave; and
estimate the proximity direction of the obstacle with respect to the electronic device based on the first proximity direction signal and the second proximity direction signal.

18. The non-transitory computer-readable storage medium of claim 17, wherein the first acoustic receiver and the second acoustic receiver are attached to the surface at two opposing positions on the surface, and are spaced apart from the surface by a same distance.

19. The non-transitory computer-readable storage medium of claim 17, wherein the acoustic transmitter includes a piezoelectric transmitter,
wherein the first acoustic receiver includes a first piezoelectric receiver, and
wherein the second acoustic receiver includes a second piezoelectric receiver.

20. The non-transitory computer-readable storage medium of claim 17, wherein the first proximity direction signal is obtained by applying signal processing to the first acoustic wave signal,
wherein the first proximity direction signal is obtained by applying signal processing to the first acoustic wave signal,
wherein the second proximity direction signal is obtained by applying signal processing to the second acoustic wave signal, and
wherein the signal processing comprises at least one from among a low-pass filter (LPF) and a fast Fourier transform (FFT).

21. The non-transitory computer-readable storage medium of claim 17, wherein the electronic device includes a first connection structure and a second connection structure,
wherein a first end of the first connection structure is connected to the first acoustic receiver, and a second end of the first connection structure is connected to the surface, such that the first acoustic receiver is spaced apart from the surface by a first distance, and
wherein a first end of the second connection structure is connected to the second acoustic receiver, and a second end of the second connection structure is connected to the surface, such that the second acoustic receiver is spaced apart from the surface by the first distance.

22. The non-transitory computer-readable storage medium of claim 21, wherein the first connection structure is configured to reduce an effect of vibrations transmitted mechanically through the electronic device on the first acoustic wave signal received by the first acoustic receiver, and
wherein the second connection structure is configured to reduce an effect of the vibrations on the second acoustic wave signal received by the second acoustic receiver.

23. The non-transitory computer-readable storage medium of claim 17, wherein the estimating of the proximity direction comprises:
comparing the first proximity direction signal and the second proximity direction signal to a first threshold value, a second threshold value, and a third threshold value,
based on the first proximity direction signal being greater than the first threshold value and the second proximity direction signal being less than the first threshold value, estimating the proximity direction to be a first direction,
based on the first proximity direction signal being less than the first threshold value and the second proximity direction signal being greater than the first threshold value, estimating the proximity direction to be a second direction,
based on the first proximity direction signal being greater than the second threshold value and the second proximity direction signal being greater than the second threshold value, estimating the proximity direction to be a third direction, and
based on the first proximity direction signal being greater than the third threshold value and the second proximity direction signal being greater than the third threshold value, estimating the proximity direction to be a fourth direction.

24. The non-transitory computer-readable storage medium of claim 17, wherein the acoustic wave generated by the acoustic transmitter comprises a chirp signal, and
wherein the instructions further cause the at least one processor to estimate the proximity direction by providing the first proximity direction signal and the second proximity direction signal to a neural network which is trained based on a dataset corresponding to the electronic device and a plurality of obstacles.
